(19) United States
(12) Patent Application Publication
(10) Pub. No.: US 2015/0146985 A1
(43) Pub. Date: May 28, 2015

(54) HANDWRITTEN DOCUMENT PROCESSING APPARATUS AND METHOD

(71) Applicant: KABUSHIKI KAISHA TOSHIBA, Tokyo (JP)

(72) Inventors: Toshiaki Nakasu, Tokyo (JP); Shihomi Takahashi, Yokohama Kanagawa (JP); Tomoyuki Shibata, Kawasaki Kanagawa (JP); Kazunori Imoto, Kawasaki Kanagawa (JP); Yasunobu Yamauchi, Yokohama Kanagawa (JP); Yojiro Tonouchi, Inagi Tokyo (JP)

(21) Appl. No.: 14/616,511

(22) Filed: Feb. 6, 2015

Related U.S. Application Data
(63) Continuation of application No. PCT/JP2013/071990, filed on Aug. 9, 2013.

(30) Foreign Application Priority Data
Aug. 10, 2012 (JP) 2012-178937

(51) Int. Cl. G06K 9/18; G06K 9/48

(52) U.S. Cl. CPC G06K 9/18; G06K 9/48
USPC 382/182

(57) ABSTRACT

According to one embodiment, a handwritten document processing apparatus is provided with a stroke acquisition unit, a stroke group generation unit and an additional information generation unit. The stroke acquisition unit acquires stroke data. The stroke group generation unit generates stroke groups each including one or a plurality of strokes, which satisfy a predetermined criterion, based on the stroke data. The additional information generation unit generates additional information which indicates a relationship between a first stroke group of the stroke groups and a second stroke group of the stroke groups, and to assign the additional information to the first stroke group.

### CROSS-REFERENCE TO RELATED APPLICATIONS

This application is a Continuation application of PCT Application No. PCT/JP2013/071990, filed Aug. 9, 2013 and based upon and claiming the benefit of priority from Japanese Patent Application No. 2012-178937, filed Aug. 10, 2012, the entire contents of all of which are incorporated herein by reference.

### FIELD

Embodiments described herein relate to a handwritten document processing apparatus and method.

### BACKGROUND

A handwritten document processing apparatus, which assigns an attribute (character or figure) to each handwritten stroke group, and processes handwritten stroke groups according to the attributes, is known.

### BRIEF DESCRIPTION OF THE DRAWINGS

FIG. 1 is an exemplary block diagram showing a handwritten document processing apparatus according to an embodiment;

FIGS. 2 and 3 are exemplary flowcharts illustrating various processings of the handwritten document processing apparatus;

FIG. 4 is a view illustrating an example of a format of ink data;

FIG. 5 is an exemplary view for illustrating the input of stroke data;

FIG. 6 is a view showing a handwritten document example for illustrating first and second attributes;

FIG. 7 is an exemplary view for illustrating additional information;

FIG. 8 is a view illustrating an example of a format of stroke group data;

FIGS. 9 and 10 are views illustrating various examples of the first and second attributes and the additional information;

FIGS. 11 and 12 are exemplary views for illustrating the separation of stroke data;

FIG. 13 is an exemplary block diagram showing stroke group data generation;

FIGS. 14-16 are exemplary flowcharts illustrating various processings of the handwritten document processing apparatus;

FIGS. 17-29 are exemplary views relevant to handwritten documents for illustrating various processings of stroke group;

FIGS. 30-33 are views illustrating various retrieval result display examples;

FIG. 34 is an exemplary block diagram showing a hardware configuration; and

FIG. 35 is a view for describing an exemplary configuration in which a network is involved.

### DETAILED DESCRIPTION

Details of a handwritten document processing apparatus according to an embodiment of the present invention will be described hereinafter with reference to the drawings. Note that components denoted by the same reference numbers in the following embodiment perform the same operations, and a repetitive description thereof will be avoided.

According to one embodiment, a handwritten document processing apparatus is provided with a stroke acquisition unit, a stroke group generation unit and an additional information generation unit. The stroke acquisition unit acquires stroke data. The stroke group generation unit generates stroke groups each including one or a plurality of strokes, which satisfy a predetermined criterion, based on the stroke data. The additional information generation unit generates additional information which indicates a relationship between a first stroke group of the stroke groups and a second stroke group of the stroke groups, and to assign the additional information to the first stroke group.

According to this embodiment, stroke groups can be processed more effectively.

In the following description, practical handwritten character examples use mainly Japanese handwritten character examples. However, this embodiment is not limited to Japanese handwritten characters, and is applicable to mixed handwritten characters of a plurality of languages.

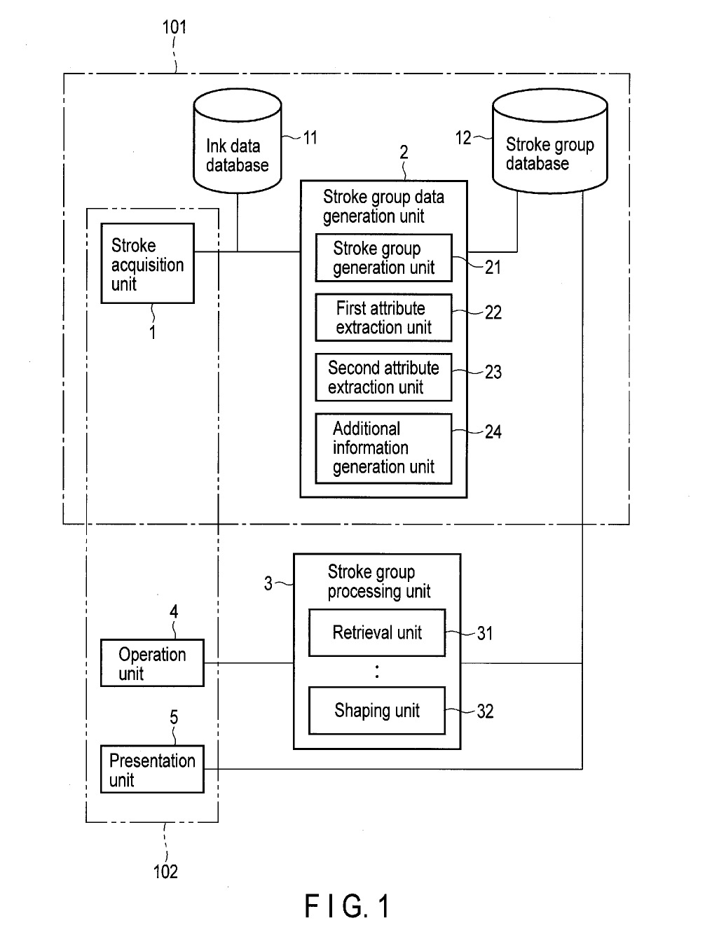

FIG. 1 shows an example of the arrangement of a handwritten document processing apparatus according to this embodiment. As shown in FIG. 1, the handwritten document processing apparatus of this embodiment includes a stroke acquisition unit 1, stroke group data generation unit 2, stroke group processing unit 3, operation unit 4, presentation unit 5, ink data database 11, and stroke group database 12.

The stroke acquisition unit 1 acquires strokes. Note that the stroke refers to a stroke (e.g., one pen stroke or one stroke in a character) which has been input by handwriting. More specifically, a stroke represents a locus of a pen or the like from the contact of the pen or the like with an input surface to the release thereof.

The ink data database 11 stores ink data in which strokes are put together in units of a document. The description below is mainly given of the case in which a stroke, which is handwritten by the user, is acquired. As the method of input by handwriting, use may be made of various methods, such as a method of input by a pen on a touch panel, a method of input by a finger on the touch panel, a method of input by a finger on a touch pad, a method of input by operating a mouse, and a method by an electronic pen.

A large number of strokes (ink data), which is handwritten by the user, is stored in ink data database 11, for example, when the user finishes writing a document or saves a document. The ink data is a data structure for storing strokes in units of a document, etc.

The stroke group data generation unit 2 generates data of stroke groups from the ink data.

The stroke group database 12 stores data of individual stroke groups. One stroke group includes one or a plurality of strokes which form a group. As will be described in detail later, for example, as for a handwritten character, a line, word, or the like can be defined as a stroke group. Also, for example, as for a handwritten figure, an element figure of a flowchart, table, illustration, or the like can be defined as a stroke group. In this embodiment, a stroke group is used as a basic unit of processing.

The stroke group processing unit 3 executes processing associated with a stroke group.

The operation unit 4 is operated by the user so as to execute the processing associated with a stroke group. The operation unit 4 may provide a GUI (Graphical User Interface).

The presentation unit 5 presents information associated with a stroke, information associated with a stroke group, a processing result for a stroke group, and the like.

Note that all or some of the stroke acquisition unit 1, operation unit 4, and presentation unit 5 may be integrated (as, for example, a GUI).

As will be described in detail later, the stroke group data generation unit 2 may include a stroke group generation unit 21, first attribute extraction unit 22, second attribute extraction unit 23, and additional information generation unit 24.

Also, the stroke group processing unit 3 may include a retrieval unit 31 and shaping unit 32.

Note that the handwritten document processing apparatus of this embodiment need not always include all the elements shown in FIG. 1.

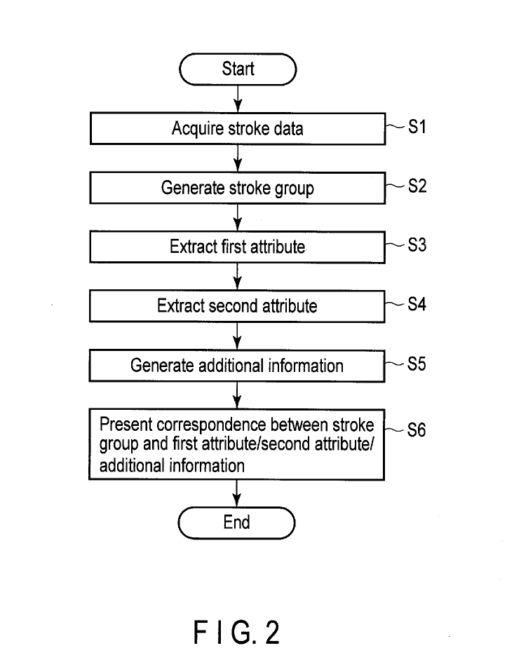

FIG. 2 shows an example of processing of the handwritten document processing apparatus of this embodiment.

In step S1, the stroke acquisition unit 1 acquires stroke data. It is preferable to acquire and use ink data which combines stroke data for a predetermined unit since efficient processing can be executed. The following description will be given under the assumption that ink data is used.

In step S2, the stroke group data generation unit 2 (stroke group generation unit 21) generates data of stroke groups from the ink data.

In step S3, the stroke group data generation unit 2 (first attribute extraction unit 22) extracts a first attribute.

In step S4, the stroke group data generation unit 2 (second attribute extraction unit 23) extracts a second attribute.

In step S5, the stroke group data generation unit 2 (additional information generation unit 24) generates additional information.

In step S6, the presentation unit 5 presents correspondence between the stroke groups and the first attribute/second attribute/additional information.

Note that steps S2 to S5 may be executed in an order different from that described above. Also, some of steps S3 to S5 may be omitted.

In step S6, presentation of some data may be omitted. Also, step S6 itself may be omitted, or all or some of the stroke groups/first attribute/second attribute/additional information may be output to an apparatus other than a display device in place of or in addition to step S6.

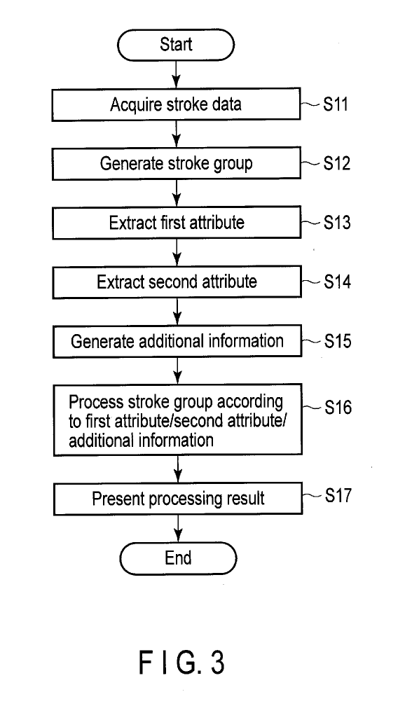

FIG. 3 shows another example of the processing of the handwritten document processing apparatus of this embodiment.

Steps S11 to S15 are the same as steps S1 to S5 in FIG. 2.

In step S16, the stroke group processing unit 3 (for example, the retrieval unit 31 or the shaping unit 32) processes a stroke group based on all or some of the first attribute/second attribute/additional information.

In step S17, the presentation unit 5 presents a result of the processing.

Note that the processing result may be output to an apparatus other than a display device in place of or in addition to step S17.

Note that FIGS. 2 and 3 are examples, and various other processing sequences are available.

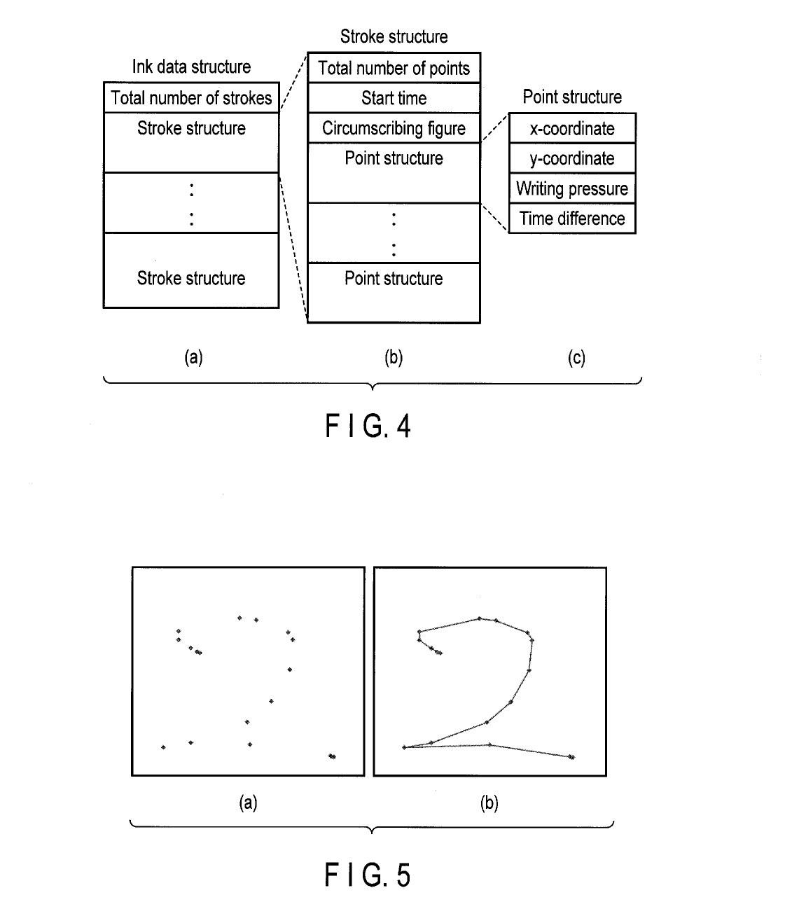

Next, referring to FIG. 4, a description is given of the data structure of ink data and the data structure of stroke data.

Usually, a stroke is sampled such that points on a locus of the stroke are sampled at a predetermined timing. For example, points on a locus handwritten by the user are sampled at regular time intervals. Thus, the stroke data is expressed by a series of sampled points.

In an example of part (b) of FIG. 4, a stroke data structure of one stroke (i.e., one handwritten stroke) is expressed by a set of coordinate values (herein after called “point structure”) on a plane on which a pen has moved. Specifically, the stroke structure is a structure including “total number of points” indicative of the number of points constituting the stroke, “start time”, “circumscribed figure”, and an array of “point structures”, the number of which corresponds to the total number of points. The start time indicates a time point at which the pen was put in contact with the input surface to write the stroke. The circumscribed figure indicates a circumscribed figure for a locus of the stroke on the document plane. Especially, the circumscribed figure is preferably a rectangle of a smallest area including the stroke on the document plane.

The structure of a point may depend on an input device. In an example of part (c) of FIG. 4, the structure of one point is a structure having four values, namely coordinate values x and y, at which the point was sampled, a writing pressure, and a time difference from an initial point (e.g. the above-described “start time”).

Note that the coordinates use a coordinate system on the document plane. For example, the coordinates may be expressed by positive values which become greater toward a lower right corner, with an upper left corner being the origin.

In addition, when the input device is unable to acquire a writing pressure or when a writing pressure, even if acquired, is not used in a subsequent process, the writing pressure in part (c) of FIG. 4 may be omitted or data indicative of invalidity may be described for the writing pressure.

In the examples of parts (b) and (c) of FIG. 4, actual data, such as coordinate values x and y, may be described in section of each point structure in the stroke structure. Alternatively, assuming that the data of the stroke structure and the data of the point structure are separately managed, link information to the corresponding point structure may be described in the section of each point structure in the stroke structure.

FIG. 5 illustrates an example of a stroke which is acquired. In the description below, for example, the case is assumed that the sampling cycle of sample points in the stroke is a predetermined time period. Part (a) of FIG. 5 shows coordinates of sampled points, and part (b) of FIG. 5 shows temporally successive point structures which are linearly interpolated. The difference in intervals of coordinates of sampling points is due to the difference in speed of writing. The number of sampling points may differ from stroke to stroke.

In an example of part (a) of FIG. 4, the data structure of ink data is a structure including “total number of strokes” indicative of the number of stroke structures included in the entire area of the document, and an array of “stroke structures”, the number of which corresponds to the total number of strokes.

In the examples of parts (a) and (b) of FIG. 4, the data of part (b) of FIG. 4 may be described in the part of each stroke structure in the ink data structure. Alternatively, assuming that the data of the ink data structure and the data structure of the stroke of part (b) of FIG. 4 are separately managed, link information to the corresponding data of part (b) of FIG. 4 may be described in the part of the data structure of each stroke in the ink data structure.

The stroke data, which has been written by the user by using the input device, is deployed on the memory, for example, by the ink data structure shown in FIG. 4. The ink data is stored as ink data database 11, for example, when the ink data is saved as a document.

Incidentally, when pluralities of documents are stored, document IDs for identifying these documents may be saved in association with each ink data. In addition, in order to identify each stroke, a stroke ID may be imparted to each stroke structure.

The stroke group data generation unit 2 (stroke group generation unit 21, first attribute extraction unit 22, second attribute extraction unit 23, and additional information generation unit 24) and stroke group database 12 will be described below.

The stroke group generation unit 21 generates a stroke group including one or a plurality of strokes which form a group that satisfies a predetermined criterion from a handwritten document (ink data). One stroke belongs to at least one stroke group.

Note that the predetermined criterion or stroke group generation method can be appropriately set or selected. For example, the predetermined criterion or stroke group generation method can be selected in association with “character” depending on which of a line, word, and character is set as a stroke group. Also, the predetermined criterion or stroke group generation method can be selected in association with “figure” depending on, for example, whether all ruled lines of one table are set as one stroke group or each individual ruled line (line segment) of one table is set as one stroke group. Also, the predetermined criterion or stroke group generation method can be selected depending on whether two intersecting line segments are set as one stroke group or two stroke groups. In addition, the stroke group generation method can be changed according to various purposes and the like.

Stroke groups may be generated by various methods. For example, stroke group generation processing may be executed at an input completion timing of a document for one page or for a previously input document for one page. Alternatively, for example, the user may input a generation instruction of stroke groups. Alternatively, the stroke group generation processing may be started when no stroke has been input for a predetermined time period. Alternatively, when strokes were input to a certain region, processing for generating stroke groups in that region may be started when no stroke has been input for a predetermined time period within a predetermined range from that region.

The first attribute extraction unit 22 extracts an attribute unique to each individual stroke group. The extracted attribute is given as a first attribute to that stroke group. The first attribute is, for example, “character” or “figure”. Another example of the first attribute is “table”, “illustration”, “mathematical expression”, or the like.

Note that the stroke group generation unit 21 and first attribute extraction unit 22 may be integrated. That is, a method of simultaneously obtaining a stroke group and first attribute may be used.

As the stroke group generation method, various methods can be used.

For example, the following methods can be used.

(1) A set of one or plurality of strokes input within a predetermined time period is defined as one stroke group.

(2) A set of one or a plurality of strokes having inter-stroke distances which are not more than a predetermined threshold is defined as one stroke group. The inter-stroke distance is, for example, a distance between barycenters of stroke positions or a distance between barycentric points of figures which circumscribe strokes. A figure which circumscribes a stroke is, for example, a polygon such as a rectangle, a circle, an ellipse, or the like.

(3) By focusing attention on neighboring line segment structures, element groups which form basic figures as a basis upon creation of a figure are extracted from the number of vertices of strokes and the types of line segments between consecutive vertices, and the extracted basic figures are separated into stroke groups each of which forms one figure based on their relative positional relationship (for example, see Haruhiko Kojima: On-line Hand-sketched Line Figure Input System by Adjacent Strawks Structure Analysis Method, Information Processing Society of Japan Technical Report Human-computer Interaction 26, pp. 1-9, [1986]).

(4) A method which combines some or all of these methods.

The above methods are examples, and the available stroke group generation method is not limited to them. Also, a known method may be used.

Note that a stroke group may be extended in a chain reaction manner. For example, when strokes a and b satisfy a condition of one stroke group, and when strokes b and c satisfy the condition of one stroke group, strokes a, b, and c may define one stroke group irrespective of whether strokes a and c satisfy the condition of one stroke group.

For an isolated stroke, one stroke group is assigned to the isolated stroke.

The first attribute extraction unit 22 extracts an attribute unique to each individual generated stroke group.

Various first attribute extraction methods are available.

For example, the first attribute extraction unit 22 applies character recognition to a stroke group, and determines based on its likelihood whether or not that stroke group is a character. When it is determined that the stroke group is a character, the first attribute extraction unit 22 may set “character” as the first attribute of that stroke group. Likewise, for example, the first attribute extraction unit 22 applies figure recognition to a stroke group, and determines based on its likelihood whether or not that stroke group is a figure. When it is determined that the stroke group is a figure, the first attribute extraction unit 22 may set “figure” as the first attribute of that stroke group. Alternatively, the first attribute extraction unit 22 may prepare for a rule [e.g., a first attribute of a stroke group including a stroke having a stroke length not less than a threshold is set as “figure”], and may apply that rule.

Note that as for handling of a stroke group which is not recognized as “character” or “figure”, various methods may be used. To a stroke group which is not recognized as “character” or “figure”, for example, a predetermined attribute (for example, “figure”) may be assigned as a first attribute. Alternatively, based on surrounding stroke groups, a first attribute may be estimated. For example, when most of first attributes of surrounding stroke groups are “character”, a first attribute of that stroke group may be recognized as “character”; when most of first attributes of surrounding stroke groups are “figure”, a first attribute of that stroke group may be recognized as “figure”.

The second attribute extraction unit 23 extracts one attribute from a set including a plurality of stroke groups (stroke group set) which are closely located (which satisfy a predetermined criterion) in a document unlike the first attribute extraction unit 22.

For example, when distances between a plurality of stroke groups are not more than a threshold, these plurality of stroke groups may be combined into one stroke group set. In this case, the stroke group set may be extended in a chain reaction manner as in the aforementioned chain reaction extension of the stroke group. Note that various methods may be used as a criterion or method required to generate one stroke group set from a plurality of stroke groups.

An attribute extracted from one stroke group set is assigned as a second attribute to each of one or a plurality of stroke groups included in that stroke group set. The second attribute is, for example, “character” or “figure”. Another example of the second attribute is “table”, “illustration”, “mathematical expression”, or the like. Note that a second attribute of one isolated stroke group may be equal to its first attribute.

Note that as for handling of a second attribute, some methods may be used. For example, both first and second attributes may be assigned to all stroke groups or a second attribute may be assigned to only a stroke group having different first and second attributes. In the latter case, no second attribute assigned means that a second attribute is equal to a first attribute.

Various second attribute extraction methods may be used.

For example, the second attribute extraction unit 23 compares an occupation ratio of a region of stroke groups having a first attribute “character” to a full region of a stroke group set with an occupation ratio of stroke groups having a first attribute “figure” to the full region of the stroke group set. When the former ratio is larger, the second attribute extraction unit 23 may set “character” as a second attribute; when the latter ratio is larger, it may set “figure” as a second attribute. Note that the full region of the stroke group set is, for example, a sum total of areas of circumscribing figures of respective stroke groups included in that stroke group set, and the region of stroke groups having the first attribute “character” is, for example, a sum total of areas of circumscribing figures of respective stroke groups having the first attribute “character”. The region of the region of stroke groups having the first attribute “figure” is, for example, a sum total of areas of circumscribing figures of respective stroke groups having the first attribute “figure”.

Alternatively, the second attribute extraction unit 23 compares a ratio of the number of stroke groups having a first attribute “character” to the number of stroke groups included in a stroke group set with a ratio of the number of stroke groups having a first attribute “figure” to the number of stroke groups included in the stroke group set. When the former ratio is larger, the second attribute extraction unit 23 may set “character” as a second attribute; when the latter ratio is larger, it may set “figure” as a second attribute.

The second attribute extraction unit 23 may directly calculate a character part and a figure part in a document from ink data. At this time, when a stroke group set corresponds to a character part, the second attribute extraction unit 23 may assign a second attribute “character”. On the other hand, when a stroke group set corresponds to a figure part, the second attribute extraction unit 23 may assign a second attribute “figure”.

Note that the stroke group generation unit 21, first attribute extraction unit 22, and second attribute extraction unit 23 may be integrated. That is, a method of simultaneously obtaining stroke groups, a first attribute, and a second attribute may be used.

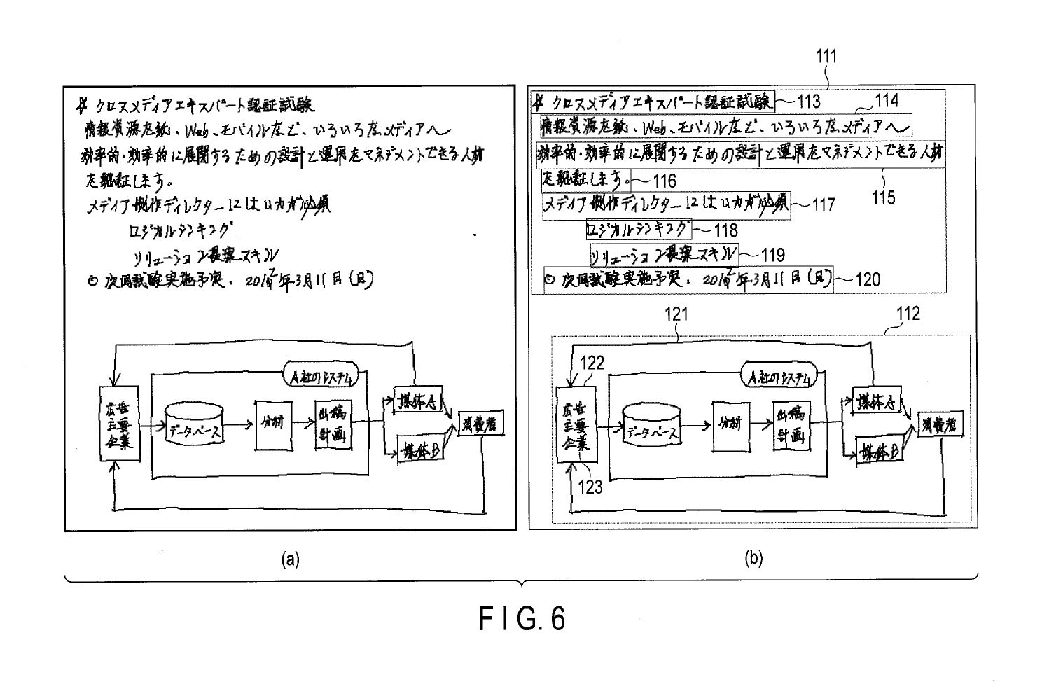

An example of stroke groups, a first attribute, and a second attribute will be described below with reference to FIG. 6.

In FIG. 6, (a) shows an example of a handwritten document (stroke sequences). In this example, a first stroke “character” is respectively assigned to stroke groups 113 to 120 in an upper portion of (b) in FIG. 6. To stroke groups 113 to 120 included in a part 111, a second attribute “character” is assigned. Also, in this example, respective flowchart elements in a lower portion of (b) in FIG. 6 are respectively stroke groups assigned a first attribute “figure”. For example, processes, a disk, lines, arrows, and the like are stroke groups assigned a first attribute “figure” (121, 122, and the like in (b) of FIG. 6). Character groups (123 and the like in (b) of FIG. 6) in the flowchart elements are respectively stroke groups assigned a first attribute “character”. A second attribute “figure” is assigned to respective stroke groups included in a part 112.

In this case, for example, a stroke group 120 is assigned a first attribute=a second attribute=“character”, and a stroke group 122 is assigned a first attribute=a second attribute=“figure”. By contrast, for example, a stroke group 123 in a stroke group 122 is assigned a first attribute=“character” and a second attribute=“figure”. Stroke group 123 itself is “character”, and forms a part of “figure” at the same time.

Note that a third attribute different from first and second attributes may be extracted and used. The same applies to fourth and subsequent attributes.

The additional information generation unit 24 generates additional information for each individual stroke group. When one or a plurality of pieces of additional information are generated for one stroke group, the generated one or a plurality of pieces of additional information are assigned to that one stroke group. No additional information may be assigned to a certain stroke group.

Note that additional information may be generated for all stroke groups, or additional information may be generated for only stroke groups having different first and second attributes.

Additional information is, for example, information indicating a relationship between two stroke groups. The relationship includes an inclusion relationship in which one stroke group is included in the other stroke group, an intersection relationship in which two stroke groups partially overlap each other, a connection relationship in which two stroke groups are connected to each other, and an adjacency relationship in which two stroke group are adjacent to each other. Note that separately located two stroke groups have none of the above relationships.

In this embodiment, assume that when one of the above relationships is detected, additional information is generated; otherwise, no additional information is generated.

In this embodiment, as for the inclusion relationship of the aforementioned relationships, additional information “including” is generated for a stroke group which includes the other stroke group, and additional information “included” is generated for a stroke group which is included in the other stroke group. As for other relationships, additional information “intersection”, “connection”, or “adjacency” is generated.

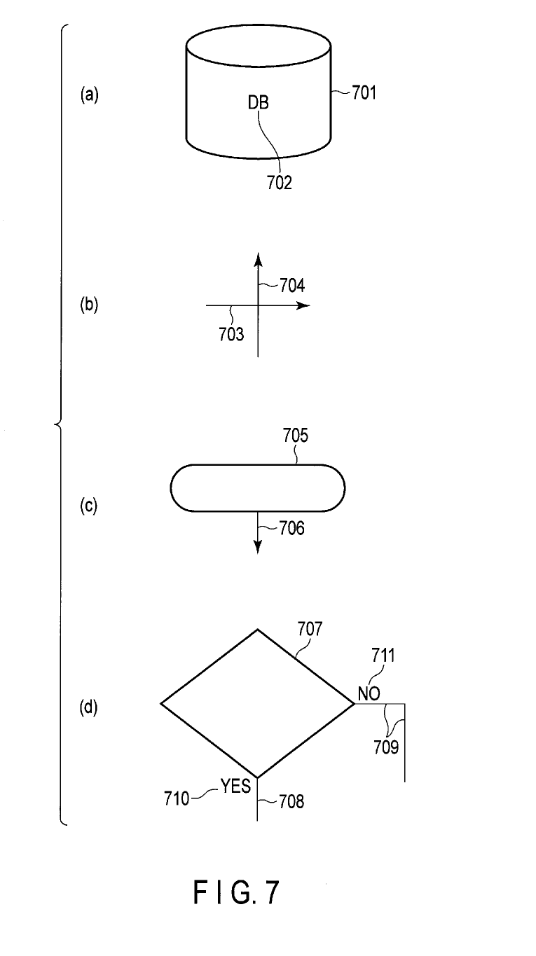

For example, in an example of (a) in FIG. 7, since a stroke group 701 includes a stroke group 702, additional information “including” is assigned to stroke group 701, and additional information “included” is assigned to stroke group 702. In an example of (b) in FIG. 7, since stroke groups 703 and 704 intersect with each other, additional information “intersection” is assigned to both stroke groups 703 and 704. In an example of (c) in FIG. 7, since stroke groups 705 and 706 are connected to each other, additional information “connection” is assigned to both stroke groups 705 and 706. In an example of (d) in FIG. 7, since stroke groups 707 and 710 are adjacent to each other, additional information “adjacency” is assigned to stroke groups 707 and 710. The same applies to stroke groups 707 and 711, stroke groups 708 and 710, and stroke groups 709 and 711. Note that stroke groups 707 and 708 and stroke groups 707 and 709 are connected to each other in addition to the above information.

Examples of a determination method of an inclusion relationship, intersection relationship, connection relationship, and adjacency relationship will be described below.

For example, polygons which circumscribe respective stroke groups are calculated, and when a circumscribing polygon of stroke group A is included in that of stroke group B, and all sampling points of stroke group B are located outside the circumscribing polygon of stroke group A, it may be determined that stroke group A is included in stroke group B. Note that in order to cope with some slightly protruding strokes, it may be determined that stroke group A is included in stroke group B when an area at a predetermined ratio or more (for example, 90% or more) of the circumscribing polygon of stroke group A is included in the circumscribing polygon of stroke group B, and sampling points at a predetermined ratio or more (for example, 90% or more) of stroke group B are located outside the circumscribing polygon of stroke group A.

When the inclusion relationship is not determined, and when circumscribing rectangles of stroke groups A and B have an overlapping region at a predetermined ratio or more (for example, 10% or more of smaller one of areas of stroke groups A and B), it may be determined that stroke group A and B intersect with each other.

When neither the inclusion relationship nor the intersection relationship is determined, and when circumscribing rectangles of stroke groups A and B have an overlapping region at less than a predetermined ratio (for example, less than 10% of smaller one of areas of stroke groups A and B), it may be determined that stroke groups A and B are connected to each other. Note that in order to cope with slightly separated strokes, even when circumscribing rectangles are separated, if their distance is not more than a very small threshold, “connection” may be determined.

When neither the inclusion relationship nor the connection relationship is determined, when a distance between circumscribing rectangles of stroke groups A and B is not more than a threshold, an adjacency relationship may be determined.

Note that the relationship determination method is not limited to the aforementioned method, and various other methods may be used.

A data structure of a stroke group will be described below.

As the data structure of a stroke group, various structures may be used.

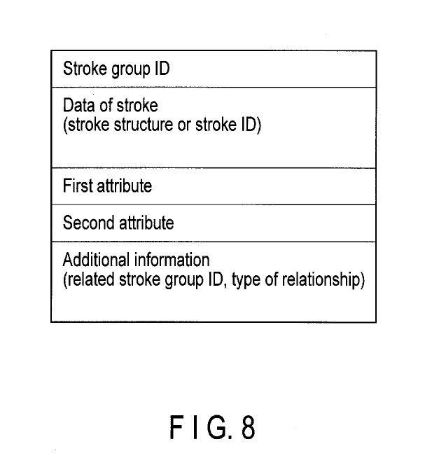

FIG. 8 shows an example of a data structure of each individual stroke group. In the example of FIG. 8, data of one stroke group includes “stroke group ID”, “data of stroke”, “first attribute”, “second attribute”, and “additional information”.

“Stroke group ID” is an identifier used to identify a stroke group in a document of interest.

“Data of stroke” is data which allows to specify one or a plurality of strokes included in that stroke group. “Data of stroke” may hold stroke structures (see (a) in FIG. 4) corresponding to individual strokes included in that stroke group, or stroke IDs corresponding to individual strokes included in that stroke group.

“First attribute” and “second attribute” are assigned one each to a stroke group.

As for “additional information”, whether or not additional information is assigned, and the number of pieces of additional information to be assigned change depending on stroke groups. Each individual additional information assigned to a stroke group includes a pair of a stroke group ID (to be referred to as “related stroke group ID”) of the other stroke group (to be referred to as “related stroke group” hereinafter) which has a relationship with that stroke group, and a type of that relationship. Note that in addition to or in place of “type of relationship”, a first attribute of the related stroke group or first and second attributes of the related stroke group may also be held.

Note that when “first attribute”, “second attribute”, or “additional information” is not used, it may be omitted from the data structure shown in FIG. 8.

Also, data of a stroke group may hold various other kinds of information.

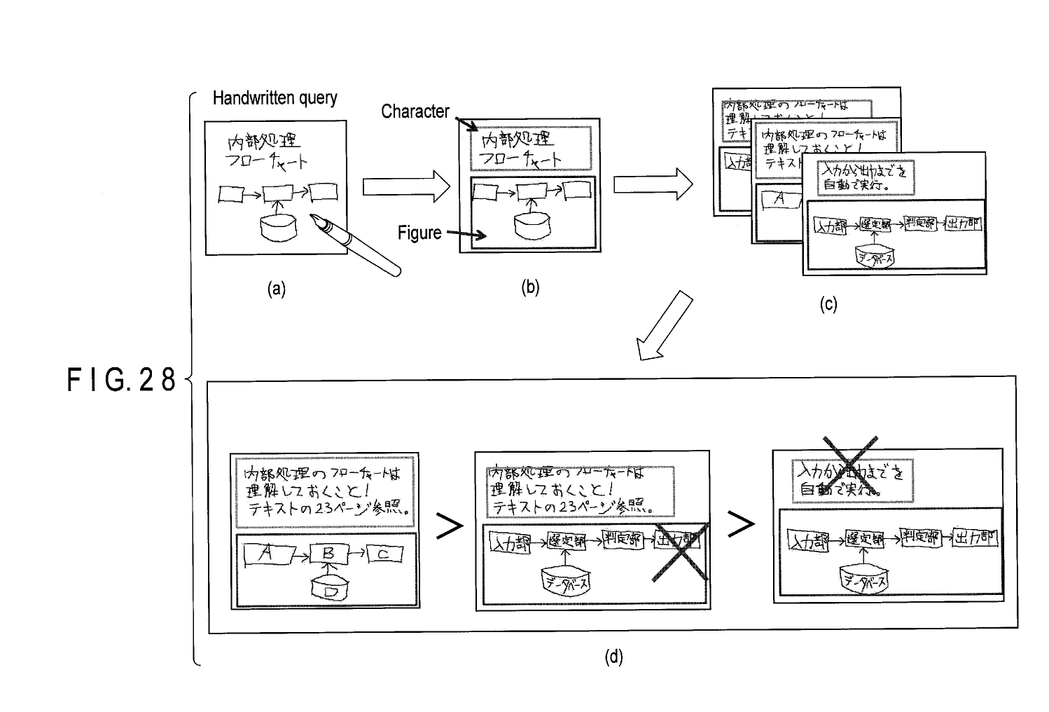

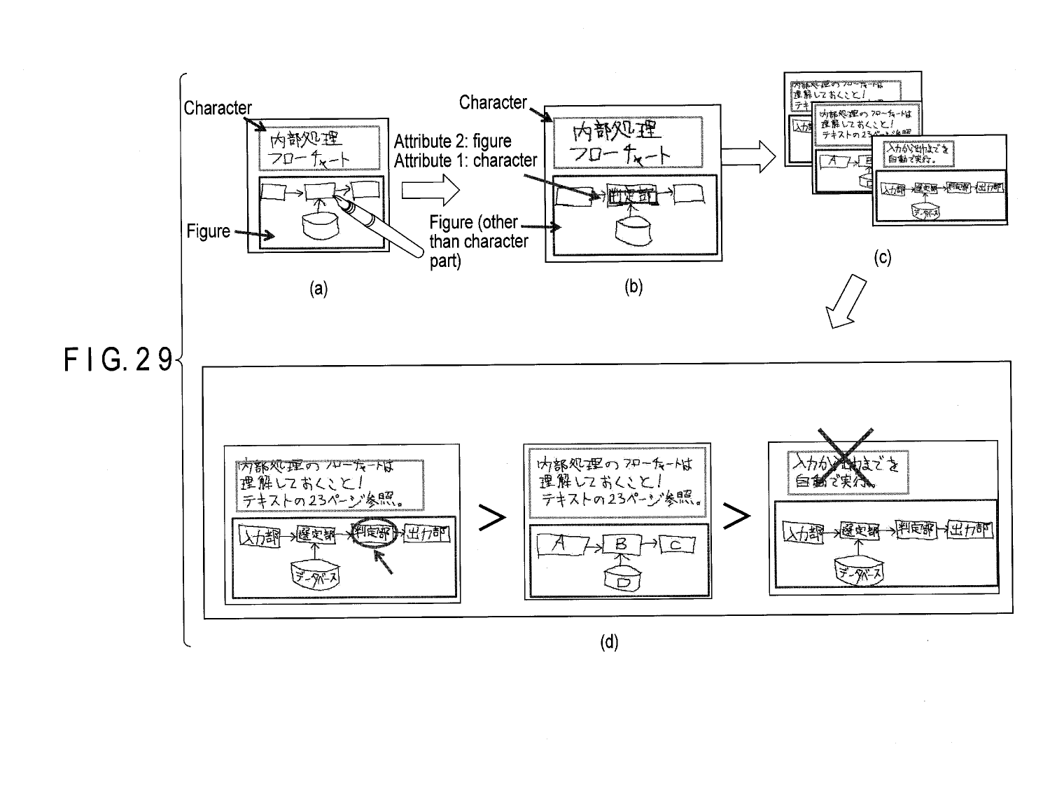

Note that the presentation unit 5 desirably has a function of presenting a relationship between a stroke group and a first attribute/second attribute/additional information. For example, in (b) of FIG. 6, character stroke groups are indicated by the rectangles 113 to 120, and a second attribute is indicated by frames 111 and 112. In addition, for example, a line type, color, or the like of the frame may be changed and presented or a phrase “character”, “figure”, or the like may be displayed, so as to allow the user to recognize whether the second attribute is “character” or “figure”. Also, in (b) of FIG. 6, rectangles indicating stroke groups in the figure part 112 are omitted, but they may be presented. Also, the first attribute may be presented to allow the user to recognize whether it is “character” or “figure”. Furthermore, the additional information (inclusion relationship, intersection relationship, connection relationship, or adjacency relationship) may be presented to allow the user to recognize it. Also, as shown in FIGS. 28 and 29, only some pieces of information may be presented.

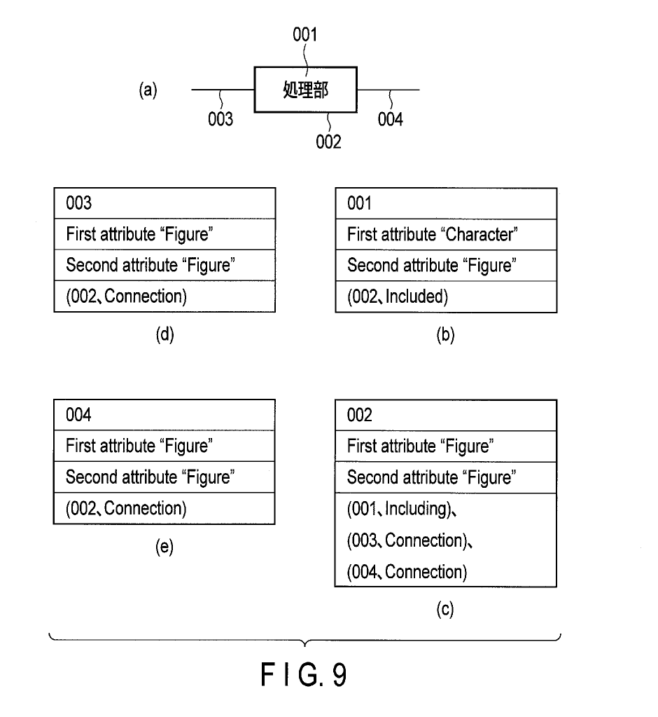

An example of a data structure of a stroke group will be described below with reference to FIG. 9.

For example, assume that ink data indicating a part of a flowchart is input, as shown in (a) of FIG. 9, and four stroke groups are generated. In this case, a stroke group having a stroke group ID=001 is included in a stroke group having a stroke group ID=002, which is connected to a stroke group having a stroke group ID=004, and is also connected to a stroke group having a stroke group ID=003. In this case, for example, data structures of the stroke groups with the stroke group ID=001 to 004 are respectively as shown in (b), (c), (d), and (e) of FIG. 9. Note that “data of stroke” is not shown in (b), (c), (d), and (e) of FIG. 9.

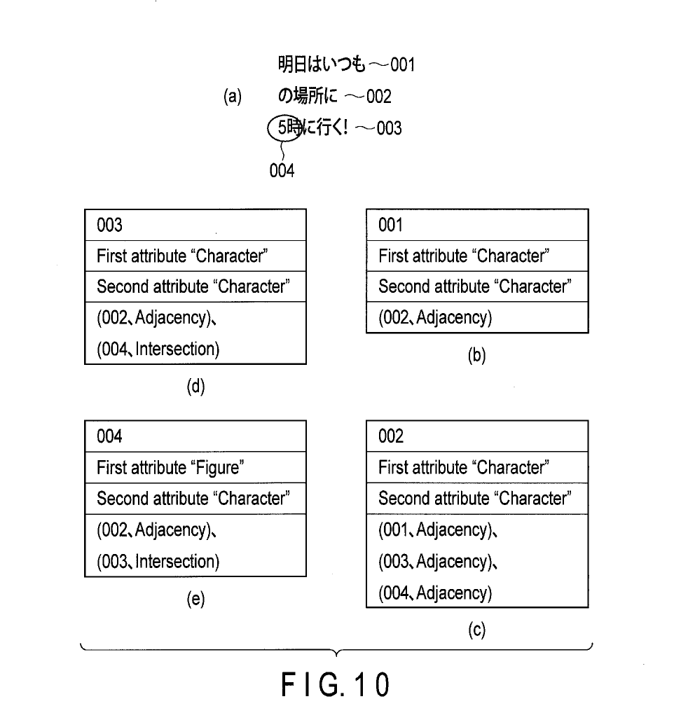

Another example of a data structure of a stroke group will be described below with reference to FIG. 10.

For example, assume that ink data indicating a part of handwritten characters and a figure is input, as shown in (a) of FIG. 10, and four stroke groups are generated. In this case, a stroke group having a stroke group ID=001 is adjacent to a stroke group having a stroke group ID=002, which is adjacent to a stroke group having a stroke group ID=003, and is also adjacent to stroke group having a stroke group ID=004, and the stroke group having the stroke group ID=003 intersects with the stroke group having the stroke group ID=004. In this case, data structures of the stroke groups with the stroke group ID=001 to 004 are respectively as shown in (b), (c), (d), and (e) of FIG. 10. Note that “data of stroke” is not shown in (b), (c), (d), and (e) of FIG. 10.

The stroke group data generation unit 2 may include at least the stroke group generation unit 21, and may further arbitrarily include the first attribute extraction unit 22, second attribute extraction unit 23, and additional information generation unit 24. For example, the following variations of the arrangement are available.
The stroke group data generation unit 2 includes the additional information generation unit 24. In this case, the processing associated with stroke groups can be executed in accordance with the additional information.
The stroke group data generation unit 2 includes the first attribute extraction unit 22 and additional information generation unit 24. In this case, the processing associated with stroke groups can be executed first attribute/additional attribute.
The stroke group data generation unit 2 includes the first attribute extraction unit 22 and second attribute extraction unit 23. In this case, the processing associated with stroke groups can be executed in accordance with the first attribute/second attribute.
The stroke group data generation unit 2 includes the first attribute extraction unit 22, second attribute extraction unit 23, and additional information generation unit 24. In this case, the processing associated with stroke groups can be executed in accordance with the first attribute/second attribute/additional information.

Another example of stroke group generation and first attribute extraction methods will be described below.

A handwritten document is separated into character parts and figure parts.

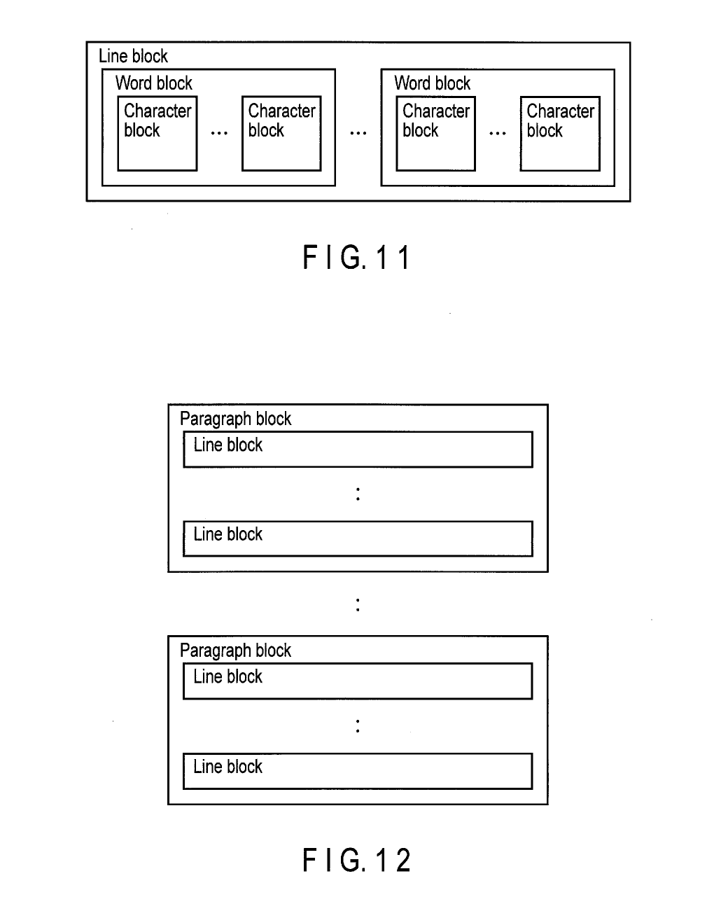

An internal part of each “character part” may further be separated into a plurality of parts. For example, as shown in FIGS. 11-12, the “character part” may be separated into “paragraph blocks”, and the “paragraph block” may be separated into “line blocks”. Further, as shown in FIGS. 11-12, the “line block” may be separated into “word blocks”. Furthermore, the “word block” may be separated into “character blocks”.

One “line block”, one “word block” or one “character block” may be defined as one stroke group. Also, one “paragraph block” can be defined as one stroke group.

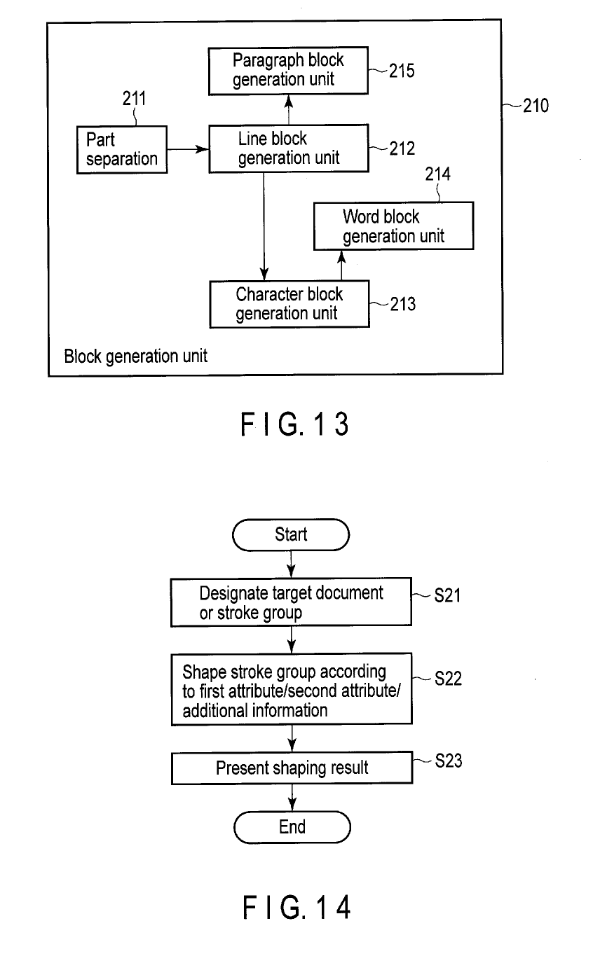

Next, referring to FIG. 13, an example of the separation process is described. A block generation unit 210 shown in FIG. 13 is an exemplary block diagram of internal functional blocks or internal processes of the stroke group data generation unit 2.

To start with, a handwritten document is separated into units of a character part, a figure part and a table part (Part separation 211).

For example, using a classifier which is pre-learnt to determine which of a character, a figure and a table each of strokes belongs to, the likelihood is calculated with respect to each stroke and is expressed by Markov random field (MRF) in order to couple with spatial proximity and continuity on a document plane. Strokes may be separated into a character part, a figure part and a table part (see, e.g. X.-D. Zhou, C.-L. Liu, S. Ouiniou, E. Anquetil, “Text/Non-text Ink Stroke Classification in Japanese Handwriting Based on Markov Random Fields” ICDAR '07 Proceedings of the Ninth International Conference on Document Analysis and Recognition, vol. 1, pp 377-381, 2007).

The classification into the character part, figure part and table part is not limited to the above method.

After the handwritten document is separated into the character part, figure part and table part, the character part is further separated into detailed parts.

To begin with, in the embodiment, separation into a part of a line block is executed (line block generation processing 212).

Each stroke data includes time information indicative of a time of writing. Thus, for example, with respect to a stroke which is sorted in the order of writing, if the distance between circumscribed rectangles of successive strokes is less than a threshold, these strokes may be determined to belong to the same line block. If the distance is equal to or greater than the threshold, these strokes may be determined to belong to different line blocks.

$$LineClassification ( i ) = \{ \begin{matrix}true , & if Dist ( {SR}_{i - 1} , {SR}_{i} ) < {threshold}_{line} \\ false , & otherwise\end{matrix}$$

The above equation is a function for determining whether an i-th stroke belongs to the same line as an immediately preceding stroke. SRᵢ indicates the circumscribed rectangle of a stroke, and Dist (r1, r2) is a function for returning a distance between circumscribed rectangles r1 and r2. In this case, the distance between circumscribed rectangles is an Euclidean distance between gravity points of circumscribed rectangles. In addition, the threshold thresholdₗᵢₙₑ is a predetermined parameter, and varies in relation to the range of a document plane on which writing is possible. It should suffice if it is understood that the range in the x-axis direction of stroke position data of a character string or the like has greatly varied, and the threshold may be set at, e.g. 30% of the range of the x axis of target ink data.

In the meantime, the stroke corresponding to a line block is not necessarily written in parallel to the axis. Thus, in order to absorb the rotation of writing, the direction of the line block may be normalized to one of three directions, namely a leftward direction, a downward direction and a rightward direction. On the document plane, a first principal component is found by principal component analysis of a line block, and the eigenvector thereof is compared to the above-described three directions, and the line block is rotated to the closest direction of the three directions. Note that when the language of writing can be specified, the direction of normalization can be limited. For example, in the case of Arabic, the direction of the line block is limited to the leftward direction. In the case of Japanese, the direction of the line block is limited to two directions, i.e. the rightward direction and downward direction.

The separation of the line block is not limited to the above method.

When one “line block” is defined as one stroke group, the separation processing can be finished. When one “word block” or one “character block” is defined as one stroke group, the next separation processing is further executed.

Next, separation into the part of the character block is executed (character block generation processing 213).

For example, a median of the short side of the circumscribed rectangle of the part of the line block, which has been separated by the above-described method, is set to be the size of one character, and separation is executed for each line block part. An AND process of circumscribed rectangles of strokes is executed in the order of writing, and a coupled rectangle is obtained. At this time, if the coupled rectangle is larger than the character size in the long-side direction of the part of the line block, a target stroke may be determined to belong to the part of a character block which is different from a character block of an immediately preceding stroke. Otherwise, the target stroke may be determined to belong to the same character block.

The separation of the character block is not limited to the above method.

When one “word block” is defined as one stroke group, the separation processing can be finished. When one “character block” is defined as one stroke group, the next separation processing is further executed.

Next, separation into the part of the word block is executed (word block generation processing 214).

The “word” in this context refers to, for example, not a word which is divided by parts of speech by morphological analysis, but a part which is more detailed than a line block and is broader than a character block. Since character recognition is indispensable for exact classification of a word, the word block does not necessarily become a word having a meaning as text information. The part of the word block may be calculated, for example, such that for the part of the line block, the character block parts belonging to the part of the line block are clustered with respect to the coordinate values of the circumscribed rectangle for the part of the character block and are separated into a k-number of clusters, and each cluster is determined to be the part of the word block.

The separation of the word block is not limited to the above method.

When one “paragraph block” is defined as one stroke group, the next separation processing is further executed after the line block separation processing.

Next, separation into the part of the paragraph block is executed (paragraph block generation processing 215).

For example, on the document plane, all strokes are projected with respect to the direction of the short side of the part of the line block, thereby obtaining a histogram in which the frequency of strokes in a fixed range is calculated. The obtained histogram has a multimodality, and each peak is classified as one paragraph block. Since the total of peaks is unknown, clustering is executed by using the condensability of frequency and the distance on the axis of projection, and thereby peaks of multimodality can be divided (see, e.g. Imamura, Fujimura, Kuroda, “A Method of Dividing Peaks in Histograms Based on Weighted Sequential Fuzzy Clustering”, Journal of the Institute of Image Information and Television Engineers, 61(4), pp. 550-553, 2007).

The separation of the paragraph block is not limited to the above method.

The stroke group data generation processing from ink data has been mainly described so far. Processing for stroke groups will be mainly described below. Note that stroke groups to be processed may be those which generated by, for example, the stroke group data generation unit 2 shown in FIG. 1 or those which are externally acquired.

The stroke group processing unit 3 will be described below.

The stroke group processing unit 3 can include one or a plurality of various processing units required to execute the processing associated with stroke groups. FIG. 1 shows, for example, the retrieval unit 31 which performs a retrieval associated with stroke groups, and the shaping unit 32 which executes shaping processing associated with stroke groups (however, this embodiment is not limited to this).

Various processes associated with stroke groups are available. For example, retrieval processing, edit processing, and the like are available. The retrieval processing includes, for example, a character retrieval, figure retrieval, page retrieval, layout retrieval, and the like. The edit processing includes, for example, character/figure shaping, font change, character/figure editing, only figure/character coloring display, and the like.

In this embodiment, all or some of processing contents can be changed according to all or some of a first attribute, second attribute, and additional information assigned to each stroke group.

For example, the following processes may be defined:

stroke groups having a first attribute=“character” are shaped after character recognition;

stroke groups having a first attribute=“figure” are shaped after figure recognition;

after that,

stroke groups without additional information are left-aligned; and

stroke groups with additional information are center-aligned.

For example, in case of the example of FIG. 6, stroke group 120 has a first attribute=second attribute=“character”, stroke group 122 has a first attribute=second attribute=“figure”, and stroke group 123 has a first attribute=“character” and second attribute=“figure”.

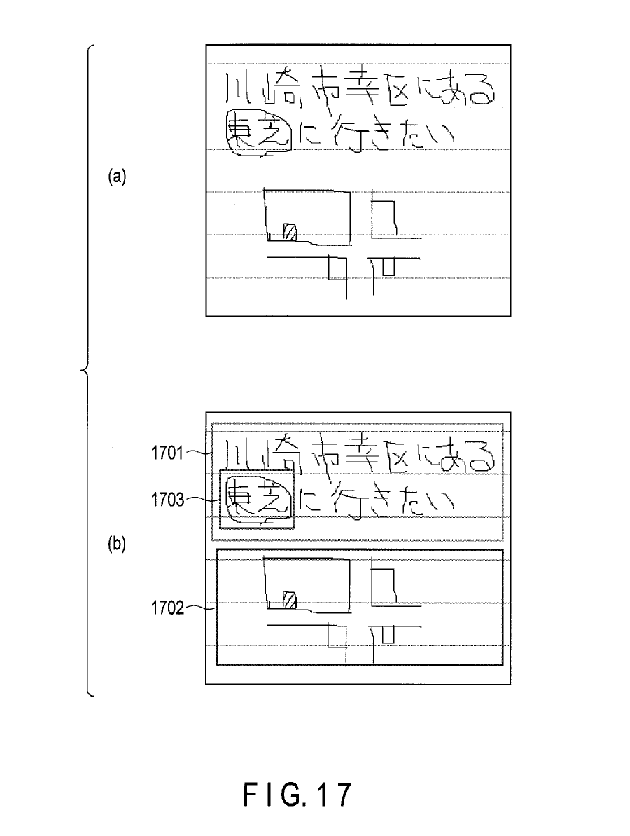

FIG. 17 shows an example different from FIG. 6. Assume that a handwritten document is input, as shown in (a) of FIG. 17. Stroke groups (except for “a loop which surrounds a character” in a block 1703) included in a part 1701 in (b) of FIG. 17 are assigned a first attribute=second attribute=“character”, and stroke groups included in a part 1702 are assigned a first attribute=second attribute=“figure”. However, a stroke group indicating “the loop which surrounds the character” in the block 1703 is assigned a first attribute=“figure” and second attribute=“character”.

For example, when “character” or “figure” is used as an attribute, as described above, there can be four types of stroke groups:
a stroke group having a first attribute=“character” and second attribute=“character”;
a stroke group having a first attribute=“figure” and second attribute=“figure”;
a stroke group having a first attribute=“character” and second attribute=“figure”; and
a stroke group having a first attribute=“figure” and second attribute=“character”.

For example, the processing contents can be changed according to an attribute of interest. For example, following processes may be executed.
Processing A1 is applied to a stroke having a first attribute=“character”, and processing A2 is applied to a stroke group having a first attribute=“figure”.
Processing B1 is applied to a stroke having a second attribute=“character”, and processing B2 is applied to a stroke group having a second attribute=“figure”.
Processing C1 is applied to a stroke group having a first attribute=“character” and second attribute=“character”, processing C2 is applied to a stroke group having a first attribute=“figure” and second attribute=“figure”, processing C3 is applied to a stroke group having a first attribute=“character” and second attribute=“figure”, and processing C4 is applied to a stroke group having a first attribute=“figure” and second attribute=“character”.

Also, some or all of a first attribute, second attribute, and additional information to be used can be selected according to processing modes. Examples of processing modes are:

mode 1: use a first attribute;

mode 2: use a second attribute;

mode 3: use additional information;

mode 4: use first and second attributes;

mode 5: use a first attribute and additional information;

mode 6: use a second attribute and additional information; and

mode 7: use first and second attributes and additional information.

Combinations of the aforementioned modes can be used.

Some processing sequence examples of the stroke group processing unit 3 will be described below.

FIG. 14 shows an example of processing of the stroke group processing unit 3.

The stroke group processing unit 3 accepts designation of a target handwritten document or stroke group in step S21, applies shaping processing to stroke groups included in the designated handwritten document or the designated stroke group according to a first attribute/second attribute/additional information in step S22, and presents the processing result in step S23.

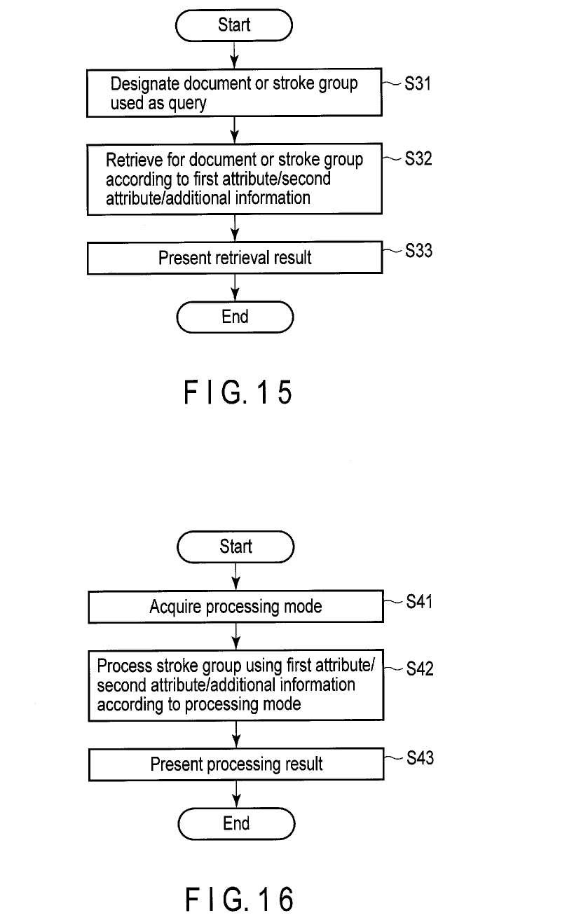

FIG. 15 shows another example of processing of the stroke group processing unit 3.

The stroke group processing unit 3 accepts designation of a handwritten document or stroke group as a query in step S31, performs a retrieval based on the query using a first attribute/second attribute/additional information in step S32, and presents the processing result in step S33.

FIG. 16 shows still another example of processing of the stroke group processing unit 3.

The stroke group processing unit 3 acquires a processing mode in step S41, processes stroke groups using a first attribute/second attribute/additional information according to the processing mode in step S42, and presents the processing result in step S43.

Note that FIGS. 14, 15, and 16 are examples, and various other processing sequences are available.

Some examples of processing for stroke groups will be described below.

<Character/Figure Shaping Processing Example>

An example of character/figure shaping processing will be described below.

For example, the following character/figure shaping processing can be executed.
Stroke groups having a first attribute=“character” (to be referred to as character stroke groups hereinafter) undergo a character recognition engine to be converted into a font format.
Stroke groups having a first attribute=“figure” (to be referred to as figure stroke groups hereinafter) undergo a figure recognition engine to fair lines.
Characters without additional information (not included in any figure) are left-aligned.
Characters with additional information are center-aligned.

Assuming that processing using additional information is not executed so as to implement the aforementioned processing, all characters are temporarily left-aligned, and those of a required portion are changed to be center-aligned, resulting in extra processes. In this embodiment, since additional information is used, the above processing can be implemented by single processing.

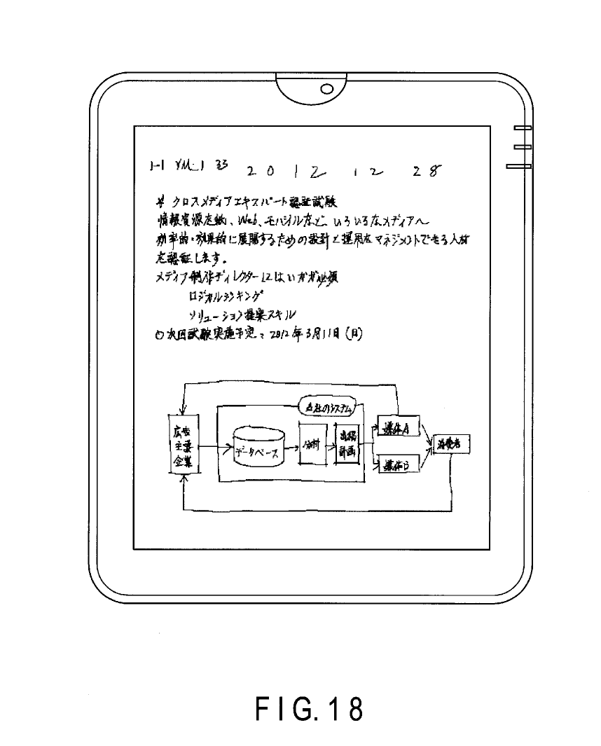

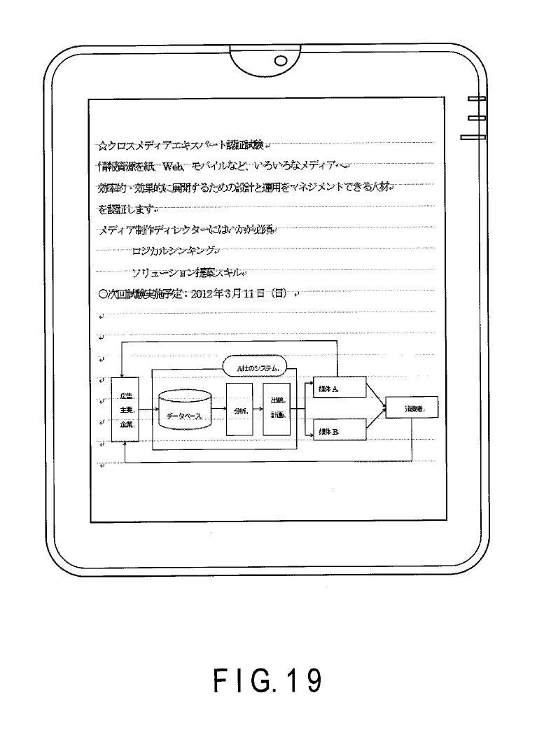

FIG. 18 shows an example of a handwritten document, and FIG. 19 shows an example of a result of shaping processing of that handwritten document.

Another example of the character/figure shaping processing will be described below.

For example, the following character/figure shaping processing can be executed.
A character stroke group which has an inclusion, intersection, or connection relationship with a figure stroke group is not shaped.
A character stroke group having an adjacency relationship with a figure stroke group is shaped. More specifically, for example, contents of a table are expressed in a handwritten state, and only a caption is shaped.

The user may select characters having a relationship to be shaped. For example, the user selects a relationship to be shaped from choices such as “inclusion”, “intersection”, . . . , and characters having the selected relationship are shaped.

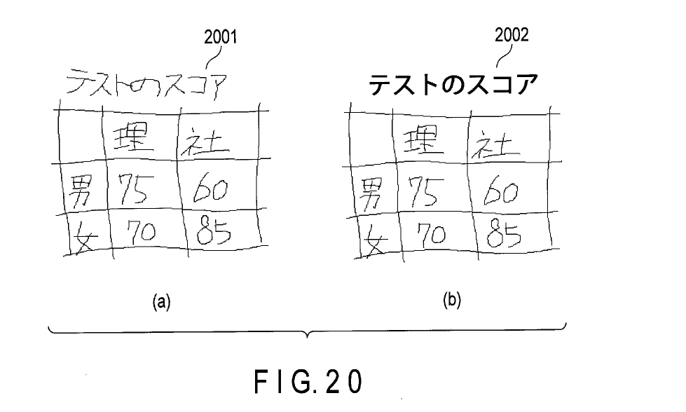

FIG. 20 shows an example of shaping processing. In FIG. 20, (a) shows an example of a handwritten document including a table and a title 2001 [ [symbol] ] (“Scores of tests” in English) which is adjacent to the table. In this case, the table is recognized, and inclusion of characters in the table is detected. More specifically, the contents of the table are detected that scores of tests are included in the table. In FIG. 20, (b) shows an example of a result in which characters included in the table have not undergone shaping processing, and only title text 2002 [ [symbol] ] (“Scores of tests” in English) adjacent outside the table has undergone shaping processing.

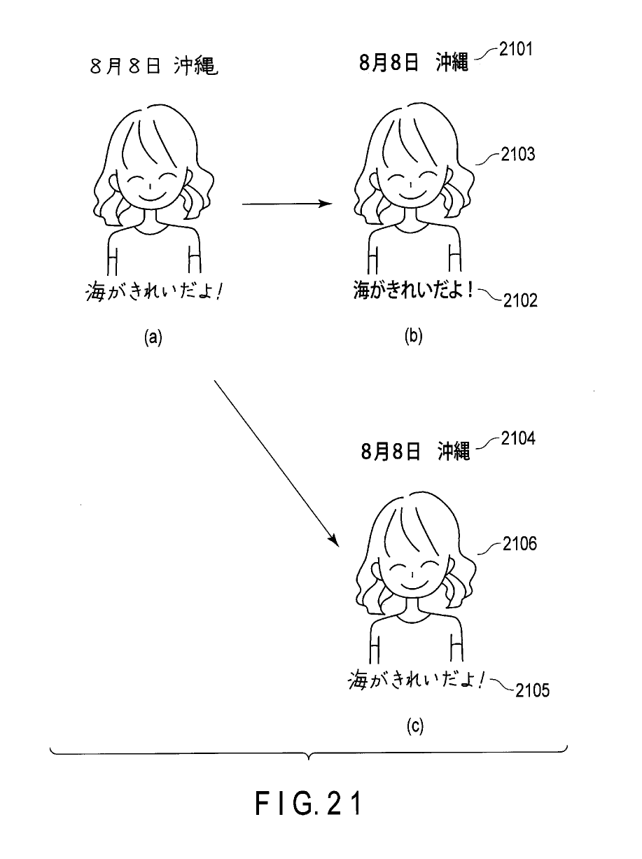

FIG. 21 shows another example of shaping processing. In FIG. 21, (a) shows a handwritten example of an illustration comment 2101-1, a comment 2101-2 [ [symbol] [symbol] !] (“Beautiful ocean!” in English), and a title 2101-3 [8 [symbol] 8 [symbol] ] (“Okinawa, August 8” in English). In FIG. 20, (b) shows a case in which handwritten characters have undergone shaping processing without shaping an illustration. A character stroke group of the title [8 [symbol] 8 [symbol] ] (“Okinawa, August 8” in English) and that of the comment [ [symbol] [symbol] !] (“Beautiful ocean!” in English) are shaped, as denoted by reference numbers 2101 and 2102. The illustration is not shaped, as denoted by reference number 2103. In FIG. 20, (c) shows an example of a result when the illustration is not shaped, handwritten characters adjacent to the illustration are not shaped, and only handwritten characters separated from the illustration are shaped. In this example, assume that the comment is adjacent to the illustration, and the title is separated from the illustration. A character stroke group of the title [8 [symbol] 8 [symbol] ] (“Okinawa, August 8” in English) is shaped, as denoted by reference number 2104, but a character stroke group of the comment [ [symbol] [symbol] !] (“Beautiful ocean!” in English) is not shaped, as denoted by reference number 2105. The illustration is not shaped, as denoted by reference number 2106.

Still another example of character/figure shaping processing will be described below.

For example, the following character/figure shaping processing can be executed.
A character stroke group is shaped.
A character stroke group, which has an inclusion, connection, or adjacency relationship with a figure stroke group, of the character stroke group is emphasized.

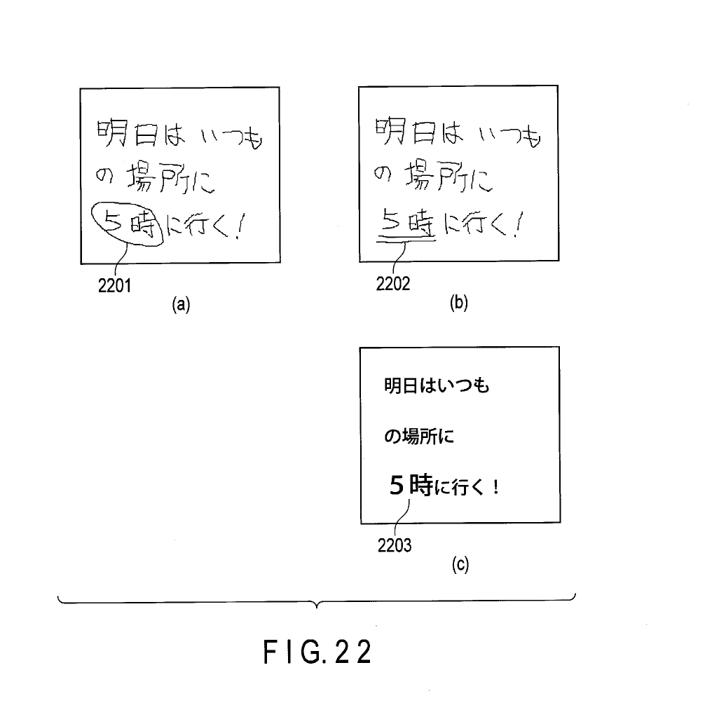

In FIG. 22, (a) and (b) show a handwritten example of a comment [ [symbol] [symbol] [symbol] !] (“Go to usual place at 5 o'clock tomorrow!” in English), and a FIG. 2201, 2202) used to emphasize a part [5 [symbol] ] (“5 o'clock” in English) in the comment. Reference number 2201 denotes an emphasis by a circle; and 2201, an emphasis by a double underline. In FIG. 22, (c) shows an example of a result in which characters have undergone shaping processing, and only characters which intersect or are adjacent to the FIG. 2201, 2202) have undergone emphasis processing (enlargement in this example). Note that the FIG. 2201, 2202) used to emphasize the characters is deleted or not displayed. Note that the emphasis processing is not limited to enlargement, and various other methods such as a method using a bold font, that using a red font, that which appends a mark, and the like can be used.

Yet another example of the character/figure shaping processing will be described below.

For example, the following character/figure shaping processing can be executed.
A character stroke group is shaped.
A character stroke group, which has an intersection or adjacency relationship with a figure stroke group, of the character stroke group, is deleted, and the remaining character stroke group is displayed to be left-aligned.

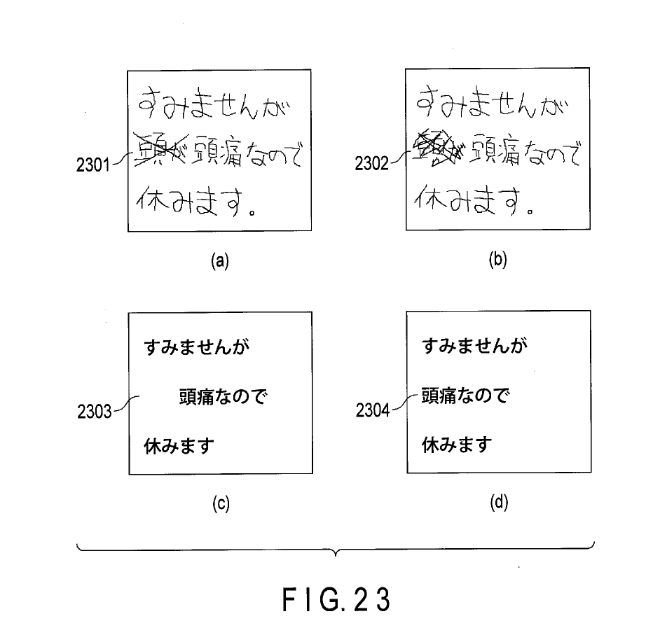

In FIG. 23, (a) and (b) show a handwritten example of a comment [ [symbol] [symbol] [symbol] ] (“Sorry, but I want a day off today because of a headache in the head” in English) and a FIG. 2301, 2302) used to delete a part [ [symbol] ] (“in the head” in English). In FIG. 23, (c) and (d) show examples of results in which characters are shaped, and only characters which intersect with the FIG. 2301, 2302) are deleted or not displayed. In FIG. 23, (c) shows the example in which a line including deleted or non-displayed characters is not left-aligned (see 2303), and in FIG. 23, (d) shows the example in which a line including deleted or non-displayed characters is left-aligned (see 2304). Note that in this example, the FIG. 2301, 2302) used to delete characters are also deleted or not displayed.

In this manner, a page on which unnecessary characters are deleted by a double line, X or the like can be shaped.

<Page Retrieval Processing>

An example of page retrieval processing will be described below.

In the embodiment, retrieval is executed from (for example, many) handwritten documents which are written in advance, by using a handwritten document (including handwriting data) which was handwritten by a user as a query. Any method may be used for the user to designate a document. For example, the query may be designated by the user actually handwriting a document. The user may create a document by arranging one or more pre-prepared templates of strokes on a layout. A document, which is to be used as the query, may be selected by the user from among existing handwritten documents. A combination of these methods may be used. Handwritten documents having layouts, which are similar to or match with the query, are presented as a retrieval result.

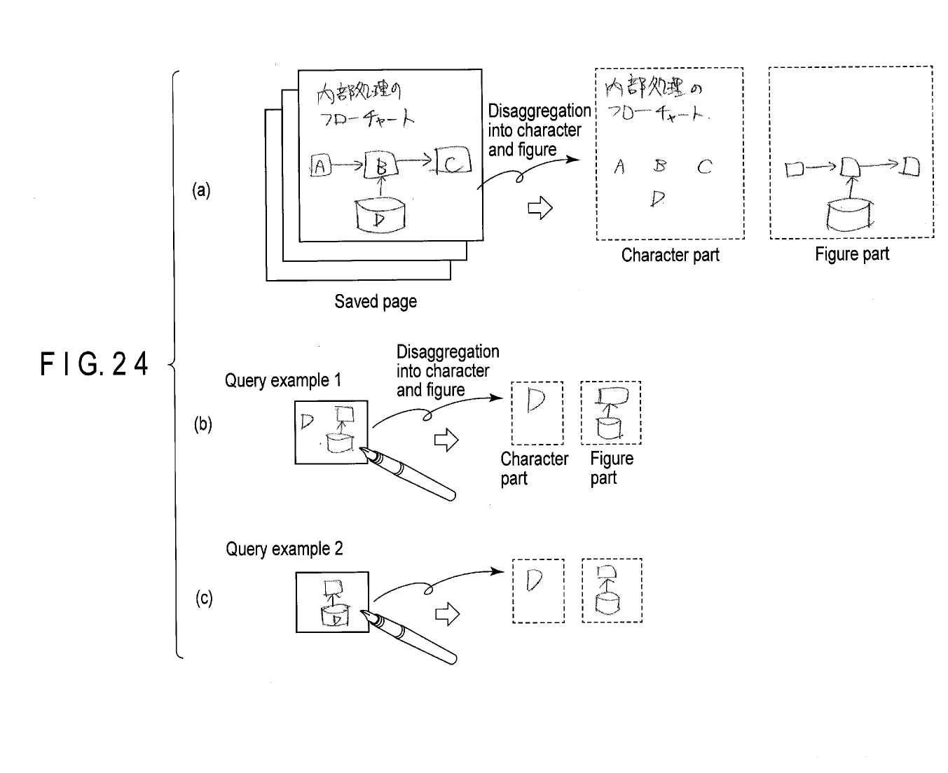

For example, a case will be examined below wherein a handwritten document shown in (a) of FIG. 24 is saved, and a query shown in (b) or (c) of FIG. 24 is designated. As exemplified in (a), (b), and (c) of FIG. 24, the handwritten document and query may be disaggregated into a character part and figure part, and matching between the handwritten document and query may be executed for the character part or figure part. In this embodiment, additional information (for example, inclusion, intersection, connection, and adjacency relationships) can be further used.

For example, a candidate which has the same connection relationship as that of the query ranks high.

For example, a candidate, which satisfies a condition that a figure stroke group has an inclusion relationship with a character stroke group or a condition that a figure stroke group does not have any inclusion relationship with a character stroke group according to the query, ranks high.

Furthermore, of such candidates, a candidate which has closer figure and character positions ranks high.

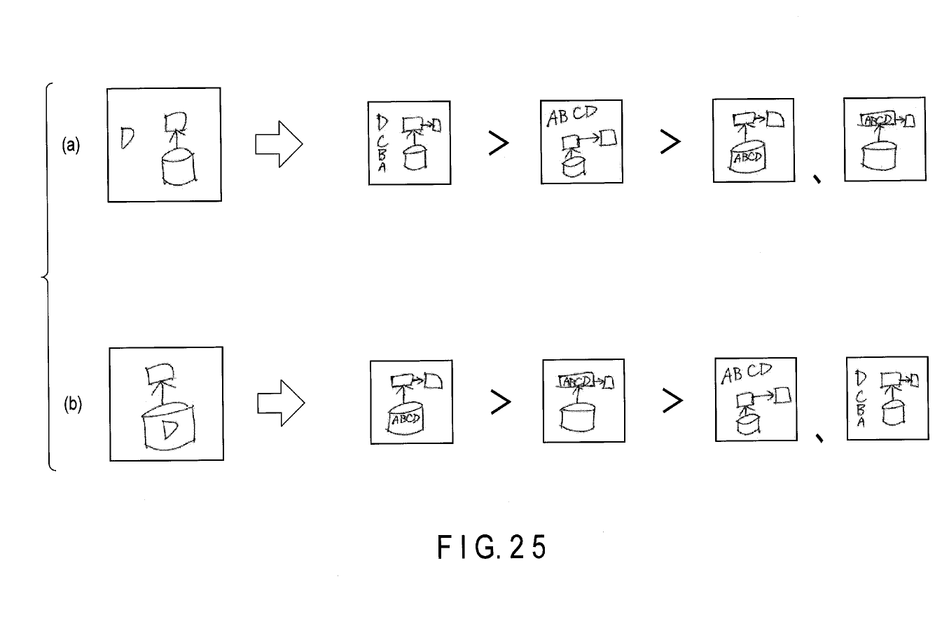

For example, in FIG. 25, (a) shows an example of a retrieval result when the query shown in (b) of FIG. 24 is designated. Inequality signs in FIG. 25 indicate the magnitude relationship of similarities of retrieved handwritten documents. In this query, since character “D” has no relationship with a figure, candidates in which character “D” has no relationship with a figure rank higher.

By contrast, in FIG. 25, (b) shows an example of a retrieval result when the query shown in (c) of FIG. 24 is designated. In this example, since character “D” has an inclusion relationship with a figure in the handwritten query, candidates in which character “D” has an inclusion relationship with a figure rank higher.

In this manner, although identical candidates are retrieved for the two queries, priority levels can be changed using the additional information depending on the query. Therefore, presentation orders or the like of candidates are different.

The user may describe only a part in his/her memory in a document as a query. When additional information of a part in his/her memory of the user is used, a desired retrieval result is likely to be obtained, and desired candidates are likely to rank higher.

Note that the retrieval result is preferably presented together with displayed pages and their relationships, thus obtaining a desired result more easily.

<Example of Processing Selection from Menu>

An example of processing selection from a menu will be described below.

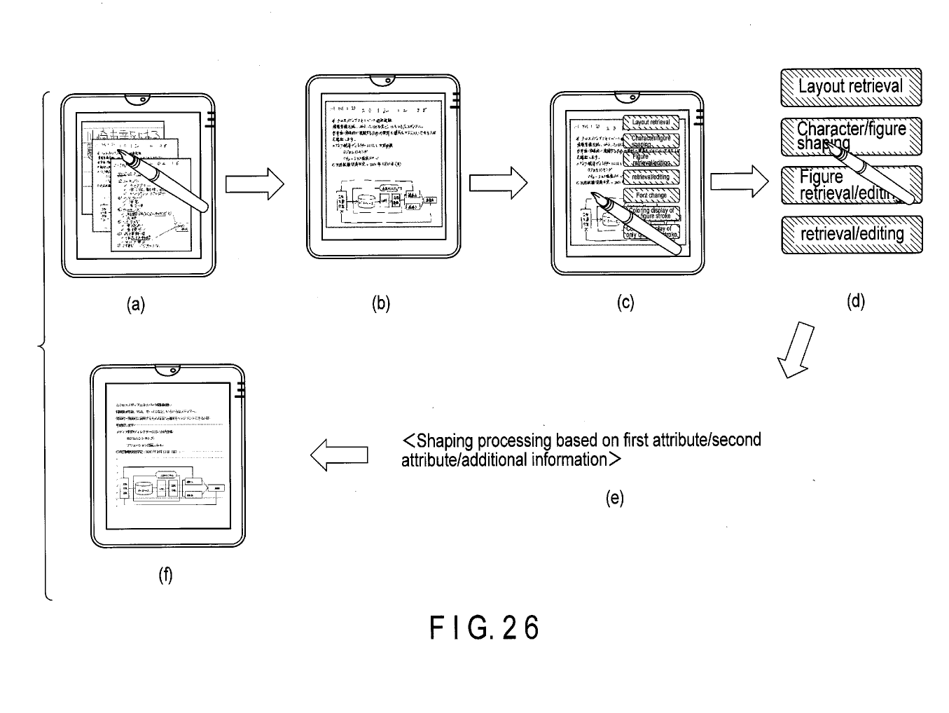

An example of character/figure shaping processing will be described below with reference to FIG. 26 as an example of a user operation.

In shaping processing, all or some of a first attribute/second attribute/additional information may be used.

(a) In an initial state of a page browse mode, the user selects a page to be shaped (a page appended with attributes).

(b) The desired page is displayed. Note that the user may handwrite a document at that site and may append attributes to the document in place of selection of an existing page.

(c) When the user clicks on the page, an operation list for that page is displayed. In the example of the operation list, “layout retrieval”, “character/figure shaping”, “figure retrieval/editing”, “character retrieval/editing”, “font change”, “coloring display of only figure stroke”, “coloring display of only character stroke”, and the like are displayed, but the embodiment is not limited to them.

(d) The user clicks “character/figure shaping” in the operation list.

(e) Shaping processing is executed. For example, shaping by means of character recognition is applied to a character part, and shaping by means of figure recognition is applied to a figure part. For example, as shown in FIGS. 18 and 19, character and figure parts are shaped as needed in a handwritten document including both a character part in an upper portion and a figure part in a lower portion.

(f) The shaped page is displayed.

(Example of User Operation: Layout Retrieval)

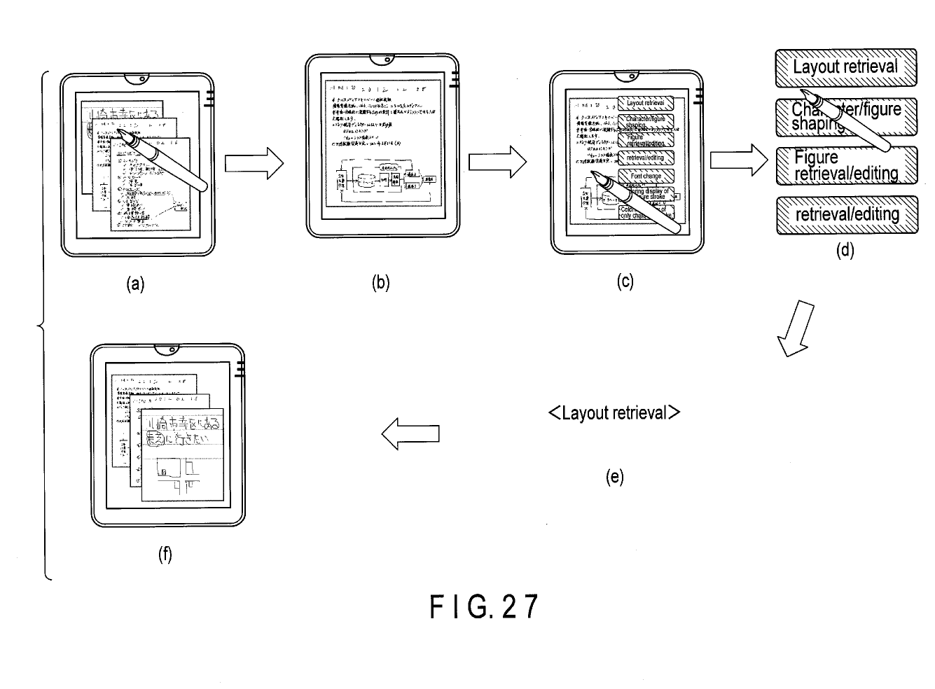

An example of a layout retrieval will be described below with reference to FIG. 27 as an example of a user operation.

In a page retrieval, all or some of a first attribute/second attribute/additional information may be used.

(a) In an initial state of the page browse mode, the user selects a page (appended with attributes) to be used as a query.

(b) The desired page is displayed. Note that the user may handwrite a page and may append attributes to that page at that site in place of selection of an existing page.

(c) When the user clicks on the page, the operation list for that page is displayed. In the example of the operation list, “layout retrieval”, “character/figure shaping”, “figure retrieval/editing”, “character retrieval/editing”, “font change”, “coloring display of only figure stroke”, “coloring display of only character stroke”, and the like are displayed, but the embodiment is not limited to them.

(d) The user clicks “layout retrieval” in the operation list.

(e) A layout retrieval is performed. For example, using all or some of a first attribute/second attribute/additional information, layouts of all pages may be analyzed. For example, the user selects a document shown in (a) of FIG. 6 as a query. For example, when a second attribute is used, the query in which an upper part 111 of the document has a second attribute “character” and a lower part 112 of the document has a second attribute “figure”, as shown in (b) of FIG. 6, is used. As a result, a document shown in FIG. 17 is retrieved, for example.

(f) A page having a layout similar to the query page is displayed.

<Example of Layout Retrieval>

An example of a layout retrieval will be described below.

FIG. 28 shows an example of a layout retrieval.

(a) The user designates a handwritten query. Note that the user may describe only a part in his/her memory.

(b) All or some of a first attribute/second attribute/additional information are assigned to the handwritten query.

(c) A layout retrieval is performed. When a plurality of pages having the same layout are retrieved, their similarities are calculated, and the retrieved pages are ranked.

In this case, character recognition processing may be applied to a character part, and a similarity of a page which includes characters in the query in that part may be set to be high. Likewise, figure recognition may be applied to a figure part, and a similarity of a page which includes a figure in the query in that part may be set to be high. Also, it may be considered that characters have a higher certainty factor than figures.

(d) Candidates are displayed in an order of similarities.

FIG. 29 shows another example of a layout retrieval.

(a) The user handwrites a query as in (a) of FIG. 28.

(b) Assume that the user further writes a text stroke group [ [symbol] ] (“determination unit” in English) in a figure stroke group.

(c) A layout retrieval is performed.

In this case, for example, character recognition processing may be applied to a character part, and a similarity of a page including characters in the query in that part may be set to be high. Likewise, when a figure part of the query includes characters, a similarity of a page including the same characters in a figure part may be set to be high. At this time, since the user does not always indicate an appropriate character position, even the character position need not always be matched, and a page including the same characters may be retrieved as a retrieval result. Also, figure recognition may also be applied to a figure part, and a similarity of a page including a figure in the query in that part may be set to be high.

(d) Candidates are displayed in an order of similarities.

The presentation unit 5 will be described below.

The presentation unit 5 presents information associated with each stroke, information associated with each stroke group, a processing result for the stroke group, and the like.

As the display method, various methods can be used.

For example, when some pages of the retrieval result are displayed, the user may switch to:
display only pages in which character and figure parts are separated;
display only pages in which character and figure parts have inclusion, intersection, connection, and adjacency relationships; or
display only pages in which character and figure parts have arbitrary combinations of hierarchical relationships.

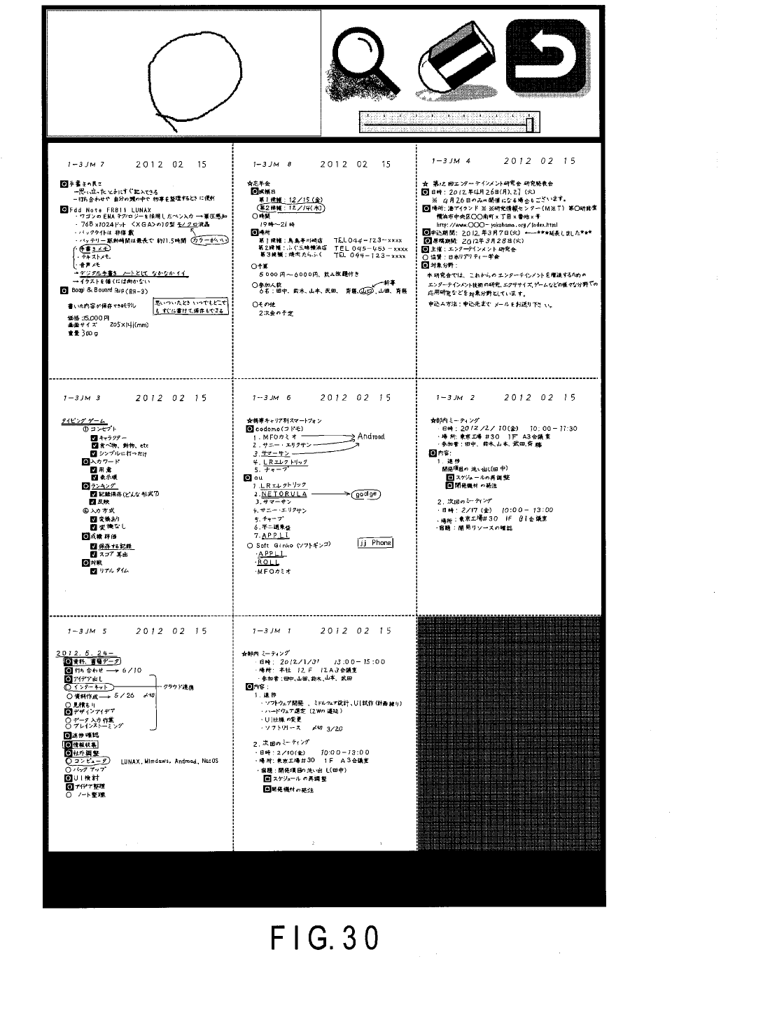

When a plurality of documents are displayed (for example, when retrieval results are displayed), as illustrated in FIG. 30, the screen of the display device may be divided into tiles, and thumbnails of documents, which are reduced in size, may be displayed on the respective tiles.

At this time, the thumbnails of documents may be arranged, for example, in a display order beginning with one including a stroke having a high degree of similarity of the retrieval result.

In addition, in the thumbnail, frames indicating various kinds of parts may be displayed.

When one page is displayed, it may be uniformly reduced, as shown in, for example, FIG. 31.

Also, when one page is displayed, for example, the user may switch to:
clip only a region of interest (a given rectangular region including a region corresponding to the query);
display only a character part; or
display only a figure part.

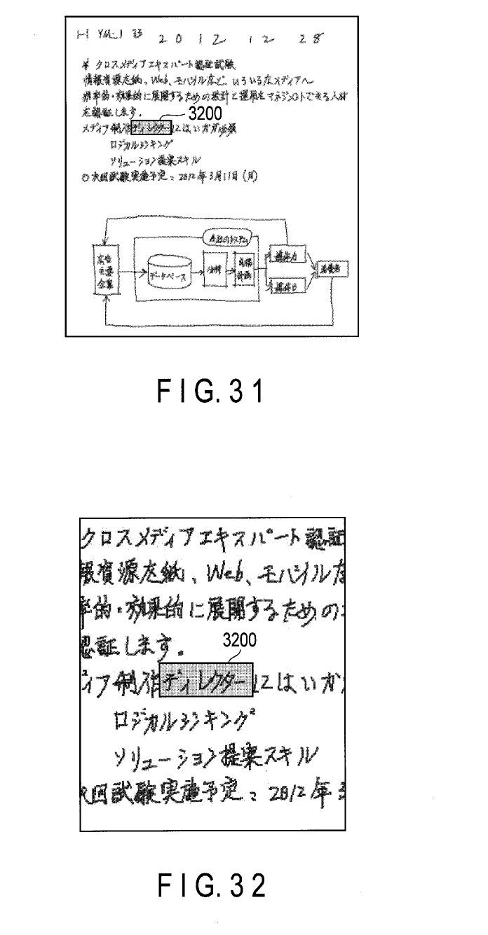

FIG. 32 shows a display example focusing on a part of characters 3200 [ [symbol] ] (“director” in English) in FIG. 31.

When one page is displayed, for example, retargeting technique may be used. According to the retargeting technique, the entire page can be recognized while making a region of interest be easier to see. The retargeting technique includes, for example:
to uniformly enlarge a region of interest, and to distort up to a given range outside the region of interest (see Japanese Patent No. 4977243); and
Seam Carving: to carve a (flat) region having a small energy other than a region of interest.

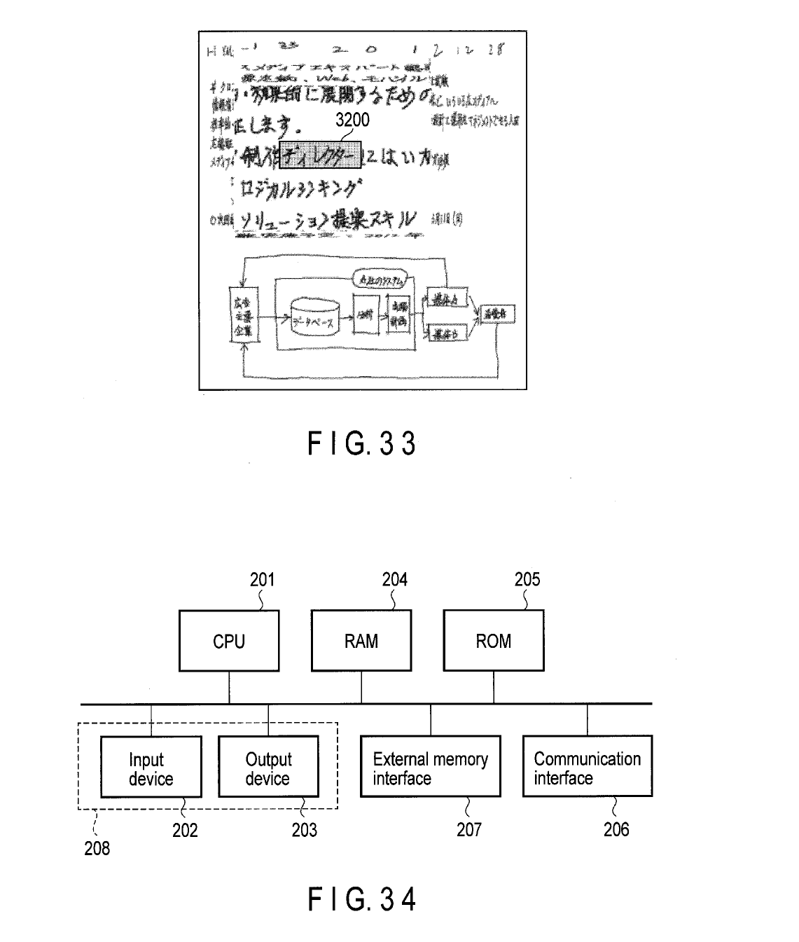

FIG. 33 shows a display example focusing on a part of the characters 3200 [ [symbol] ] (“director” in English) in FIG. 31.

Also, for example, as for an order of pages to be displayed, various variations are available. For example, the user may select a relationship to be displayed as higher ranks irrespective of relationships in a query page in a page retrieval.

The aforementioned attributes are presented once to the user, and the user may change the attributes. For example, the user may be allowed to assign “character” as a first attribute. The user may designate an attribute (“character” or “figure”) of a part to be written. Some attribute candidates such as “character” and “figure” may be presented on an input terminal, and the user can assign that attribute candidate. Alternatively, the user may select an attribute according to a character/figure input mode as a first or second attribute.

Next, variations of the present embodiment are described.

The stroke group processing unit 3 of the handwritten document processing apparatus of the embodiment may use, as retrieval targets, handwritten documents which are stored in the handwritten document processing apparatus. Alternatively, when the handwritten document processing apparatus is connectable to a network such as an intranet and/or the Internet, the retrieval unit 7 may use, as retrieval targets, handwritten documents which can be accessed via the network. Alternatively, the retrieval unit 7 may use, as retrieval targets, handwritten documents which are stored in a removable memory that is connected to the handwritten document processing apparatus. Besides, retrieval targets may be an arbitrary combination of these handwritten documents. It is desirable that as regards these handwritten documents, at least the same feature values as the feature values, which are used in the retrieval in the embodiment, are associated and stored.

The handwritten document processing apparatus of the embodiment may be configured as a stand-alone apparatus, or may be configured such that the handwritten document processing apparatus is distributed to a plurality of nodes which are communicable via a network.

The handwritten document processing apparatus of the embodiment can be realized by various devices, such as a desktop or laptop general-purpose computer, a portable general-purpose computer, other portable information devices, an information device with a touch panel, a smartphone, or other information processing apparatuses.

FIG. 34 illustrates an exemplary block diagram of the hardware which realizes the handwritten document processing apparatus of the embodiment. In FIG. 13, numeral 201 is a CPU, 202 is an appropriate input device, 203 is an appropriate output device, 204 is a RAM, 205 is a ROM, 206 is an external memory interface, and 207 is a communication interface. For example, when a touch panel is used, use is made of, for instance, a liquid crystal panel, a pen, and a stroke detector which is provided on the liquid crystal panel (see 208 in FIG. 13).

In addition, for example, a part of the structure of FIG. 1 may be provided on a client, and the other part of the structure of FIG. 1 may be provided on a server.

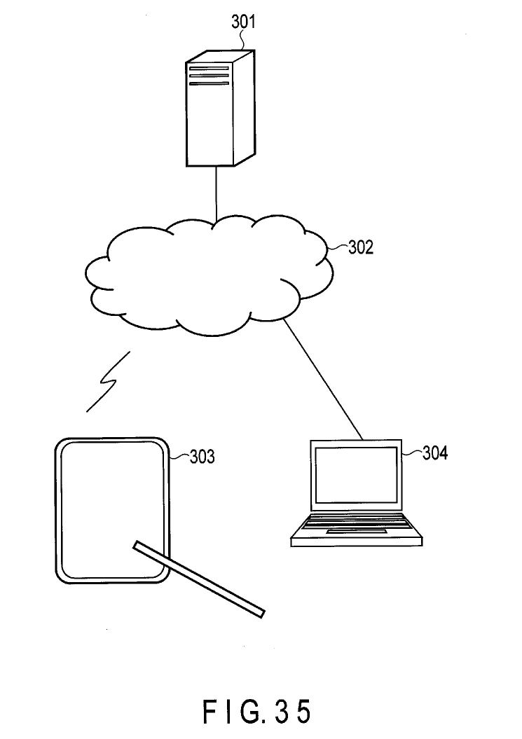

For example, FIG. 35 illustrates a state in which a server 301 exists on a network 302 such as an intranet and/or the Internet, and each client 303, 304 communicates with the server 301 via the network 302, thereby realizing the handwritten document processing apparatus of the embodiment.

The case is illustrated that the client 303 is connected to the network 302 by wireless communication and the client 304 is connected to the network 302 by wired communication.

Usually, the client 303, 304 is a user apparatus. The server 301 may be, for example, a server provided on a LAN such as an intra-company LAN, or a server which is operated by an Internet service provider. Besides, the server 301 may be a user apparatus by which one user provides functions to another user.

Various methods are thinkable as a method of distributing the structure of FIG. 1 to a client and a server.

For example, in FIG. 1, the range indicated by 102 may be mounted on the client side, and the other range may be mounted on the server side. Alternatively, only the stroke group processing unit 3 may be mounted on the server side, and the other range may be mounted on the client side.

Note that an apparatus including the range of 101 in FIG. 1, or an apparatus including a range, which excludes the acquisition unit 1 from 101 in FIG. 1, may be realized. In this case, this apparatus has a function of generating data of stroke groups from a stroke sequence. In addition, for example, the range indicated by 102 in FIG. 1 may be mounted on the client side, the stroke group processing unit 3 may be mounted on a first server, and the range, which excludes the stroke acquisition unit 1 from 101, may be mounted on a second server.

Other distribution methods are also possible.

As described above, according to this embodiment, since processing for stroke groups is executed using all or some of a first attribute/second attribute/additional information, stroke groups can be processed more effectively.

The instructions included in the procedures in the above-described embodiments can be executed based on a program as software. Further, the same advantage as obtained by the handwritten document processing apparatus of the embodiments can also be obtained by beforehand storing the program in a versatile computing system and reading it. The instructions described in the above-described embodiments are recorded, as a program for causing a computer to execute them, on a recording medium, such as a magnetic disk (a flexible disk, a hard disk, etc.), an optical disk (a CD-ROM, a CD-R, a CD-RW, a DVD-ROM, a DVD±R, a DVD±RW, etc.), a semiconductor memory, or a recording medium similar to them. The recording scheme employed in the recording mediums is not limited. It is sufficient if the computer or a built-in system can read the same. If the CPU of the computer reads the program from the recording medium and executes the instructions written in the program, the same function as in the handwritten document processing apparatus of the embodiments can be realized. It is a matter of course that the computer acquires the program via a network.

Further, the OS (operating system) operating on the computer, database management software, middleware such as a network, etc., may execute part of each process for realizing the embodiments, based on the instructions in the program installed from a recording medium into the computer or the built-in system.

Yet further, the recording medium in the embodiments is not limited to a medium separate from the computer or the built-in system, but may be a recording medium into which a program acquired via a LAN, the Internet, etc., is stored or temporarily stored.

In addition, a plurality of mediums, from which programs are read to execute the process steps of the embodiments, may be employed.

The computer or the built-in system in the embodiments are used to execute each process step in the embodiments based on the program stored in the recording medium, and may be a personal computer or a microcomputer, or be a system including a plurality of apparatuses connected via a network.

The computer in the embodiments is not limited to the above-mentioned personal computer, but may be an operational processing apparatus incorporated in an information processing system, a microcomputer, etc. Namely, the computer is a generic name of a machine or an apparatus that can realize the functions of the embodiments by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A handwritten document processing apparatus comprising:
a stroke acquisition unit configured to acquire stroke data;
a stroke group generation unit configured to generate stroke groups each including one or a plurality of strokes, which satisfy a predetermined criterion, based on the stroke data; and
an additional information generation unit configured to generate additional information which indicates a relationship between a first stroke group of the stroke groups and a second stroke group of the stroke groups, and to assign the additional information to the first stroke group.

2. The apparatus of claim 1, wherein the relationship is one of a relationship in which the first stroke group includes the second stroke group, a relationship in which the first stroke group is included in the second stroke group, a relationship in which the first stroke group and the second stroke group intersect each other, a relationship in which the first stroke group and the second stroke group are connected to each other, and a relationship in which the first stroke group and the second stroke group are adjacent to each other.

3. The apparatus of claim 1, further comprising a stroke group processing unit configured to process the stroke groups based on the additional information assigned to the stroke groups.

4. The apparatus of claim 2, further comprising:
a first attribute extraction unit configured to extract a first attribute in associate with each individual stroke group, and to assign the first attribute to the stroke group; and
a second attribute extraction unit configured to extract a second attribute in association with a stroke group set including a plurality of stroke groups which satisfy a predetermined criterion, and to assign the second attribute to each of the stroke groups included in the stroke group set.

5. The apparatus of claim 4, wherein the additional information is generated for only a stroke group having the first attribute and the second attribute which are different from each other.

6. The apparatus of claim 4, further comprising a stroke group processing unit configured to process the stroke groups based on at least the second attribute or the additional information of the first attribute, the second attribute, and the additional information assigned to the stroke groups.

7. The apparatus of claim 4, further comprising a stroke group processing unit configured to process the stroke groups based on all or some of the first attribute, the second attribute, and the additional information assigned to the stroke groups in correspondence with a designated processing mode.

8. The apparatus of claim 4, wherein the first attribute and the second attribute are character or figure.

9. The apparatus of claim 3, wherein the processing is shaping processing or retrieval processing.

10. The apparatus of claim 1, further comprising a presentation unit configured to present a correspondence among the first stroke group, the second stroke group, and the relationship indicated by the additional information.

11. A handwritten document processing method of a handwritten document processing apparatus, comprising:
acquiring, at the handwritten document processing apparatus, stroke data;
generating, at the handwritten document processing apparatus, stroke groups each including one or a plurality of strokes, which satisfy a predetermined criterion, based on the stroke data; and
generating, at the handwritten document processing apparatus, additional information which indicates a relationship between a first stroke group of the stroke groups and a second stroke group of the stroke groups, and assigning the additional information to the first stroke group.

12. A non-transitory computer-readable medium storing a computer program which is executed by a computer to provide steps of:
acquiring stroke data;
generating stroke groups each including one or a plurality of strokes, which satisfy a predetermined criterion, based on the stroke data; and
generating additional information which indicates a relationship between a first stroke group of the stroke groups and a second stroke group of the stroke groups, and assigning the additional information to the first stroke group.
